(19) United States
(12) Patent Application Publication
(10) Pub. No.: US 2008/0038241 A1
(43) Pub. Date: Feb. 14, 2008

(54) Self-Polishing Anti-Fouling coating Compositions Comprising An Enzyme

(75) Inventors: Ad Schasfoort, Eindhoven (NL); Jacco Eversdijk, Xw's-Hertogenbosch (NL); Knud Allermann, Rungsted Kyst (NL); Ib Schneider, Gentofte (NL); Peter Willemsen, Schagen (NL)

Correspondence Address: GIFFORD, KRASS, SPRINKLE,ANDERSON & CITKOWSKI, P.C, PO BOX 7021, TROY, MI, 48007-7021, US

(73) Assignee: BioLocus A/S, Horsholm (DK)

(21) Appl. No.: 11/571,158

(22) PCT Filed: Jun. 29, 2005
(86) PCT No.: PCT/DK05/00440

§ 371 Date: Jul. 8, 2007

(30) Foreign Application Priority Data
Jul. 1, 2004 (DK) PA 2004 01045

(51) Int. Cl. C09D 5/16

(52) U.S. Cl. 424/94.3; 106/4

(57) ABSTRACT

The present invention relates to self-polishing, anti-fouling coating compositions comprising an enzyme, methods for producing such coating compositions and uses thereof. The coating composition can comprise e.g. a pigment in which case the coating composition can be used as a painting composition. In a first aspect, the invention relates to a self-polishing anti-fouling coating composition comprising a first enzyme having anti-fouling activity, and at least one hydrolysable polymer composition capable of being non-enzymatically hydrolysed in an aqueous environment. In a further aspect there is provided a self-polishing anti-fouling coating composition comprising a first enzyme having anti-fouling activity, a second enzyme having polymer-hydrolysing activity, and at least one hydrolysable polymer composition capable of being hydrolysed by said second enzyme. In the latter case, the first enzyme does preferably not contribute to the self-polishing effect. The second enzyme typically does not have a direct anti-fouling species.

### TECHNICAL FIELD OF THE INVENTION

The present invention relates to self-polishing, anti-fouling coating compositions comprising an enzyme, methods for producing such coating compositions and uses thereof. The coating composition can comprise e.g. a pigment in which case the coating composition can be used as a painting composition.

### BACKGROUND OF THE INVENTION

All surfaces in aquatic environments are subject to intense fouling pressure by bacteria, protozoa, algae and invertebrates. This process is called fouling. The control of fouling is of particular concern to marine shipping operations and marine engineering (offshore constructions, heat exchangers, marine sensors, water inlets, aquaculture constructions etc.). Fouling on the hulls of ships for example increases frictional drag with a corresponding decrease in speed and manoeuvrability and an increase in fuel consumption and increased maintenance costs associated with removal of the fouling. Furthermore, even a small number of organisms attaching themselves to the propellers of a ship can significantly reduce the propellers' efficiency or create corrosion problems.

An important group of marine organisms that contributes significantly to the fouling process is the group of crustacean organisms that are commonly referred to as barnacles. These organisms belong to the Cirripedia subclass of the order Crustacea. A common feature for Cirripedia is that the adult stages are sessile and become attached to solid surfaces by the secretions of a cement gland on their first antenna. The Cirripedia subclass includes four orders: Thoracica, Acrothoracica, Ascothorica and Rhizocephala. Of these, organisms of Thoracica that belongs to the genus Balanus, also referred to as acorn shell or rock barnacles, are commonly involved in fouling of submerged surfaces such as ship hulls.

Conventional biocidal anti-fouling coating compositions depend for their effectiveness on both the biocide itself and the technology used to control the biocide release, i.e. the technology used to control the leaching rate. Copper is the main biocide used in TBT-free anti-fouling compositions in combinations with rapidly degrading boosting biocides which do not bio-accumulate in the marine environment. The release of the biocides is typically controlled using one of three technologies:

Rosin-Based Controlled Release Technologies

Rosins, or chemical derivatives of rosins, allow seawater to penetrate the paint film, and as it does so, it dissolves the biocides contained therein thus allowing their release by a diffusion process.

This results in an “exponential” leaching rate, with an excessive release in the early days of immersion which falls quite rapidly, eventually to a level which is too low to prevent fouling.

One major rosin constituent is abietic acid, which is slightly soluble in sea water (pH ˜8.2), and it is this slight solubility which makes it suitable for use in anti-fouling coating compositions. Purification of rosin, to improve its solubility, can be carried out in a number of ways, such as hydrogenation or esterification.

Rosins are not film-forming materials and other film-forming components or coating composition components will have to be added to the coating composition in addition to a rosin containing material. Such film-forming components are often referred to as resins or plasticizers. It is the resins which provide films of good mechanical strength.

As the above-mentioned added components are generally insoluble in seawater, their amount in coating compositions will have to be limited in order not to impair biocide leaching to an undesirable low degree. A careful balance is needed between the amount of rosin required to provide sufficient biocide release and the quantity of the other film-forming components used to make the coating tough and durable.

As the rosin content increases, the coating composition becomes softer and more soluble in seawater. In contrast, a low rosin content makes the coating composition system virtually insoluble and hard.

Anti-fouling compositions which are softer and more soluble are known as “Controlled Depletion Polymer” (CDP), or “Soluble Matrix” (SM) anti-fouling compositions, whereas the hard types are known as “Insoluble Matrix” (IM) or “Contact Leaching” (CL) anti-fouling compositions.

Another type of anti-fouling compositions are known as “Self-Polishing Copolymer” (SPC) anti-fouling compositions. Hybrid SPC/CDP systems have also been described.

Controlled Depletion Polymer (CDP) Anti-Fouling Compositions

Until the 1930's almost all anti-fouling paints were of the CDP type, which at that time were referred to as “Soluble Matrix”. In the late 1940's major improvements came about with the advent of a wide range of new industrial film forming materials such as the synthetic petroleum-based resins.

As chemical companies developed these new resins they were used to upgrade and improve CDP anti-fouling compositions, giving them increased film integrity and toughness. Continual improvement has resulted in the CDP anti-fouling compositions available today.

Most Marine paint companies market their own versions of CDP anti-fouling compositions, and use a wide variety of nomenclatures to describe them. Typical of these are “Eroding”, “Ablative”, “Polishing”, “Hydration”, “Ion Exchange”, “Hydrolysable Activated” and “Self-Polishing”. The common feature in all of these products is the high proportion (>50%) of rosin, or rosin derivatives, in the coating composition.

Although in theory these paints can dissolve or polish away fully over time, this does not happen in practice since the surface becomes increasingly less soluble due to the build up of insoluble copper salts and other inert species (such as rosin impurities and insoluble film forming coating composition components).

The build up of largely insoluble material in CDP anti-fouling compositions results in the development of a thick, leached layer through which the biocides have to diffuse to the surface. This limits the lifetime of CDP anti-fouling compositions e.g. on a vertical side of a ship hull to a maximum of 36 months between dry-dockings (depending on in-service conditions and specification applied). On the flat bottom of the hull, where the fouling challenge is less severe, in-service periods can be extended up to 60 months (depending on in-service conditions and specification applied).

Contact Leaching (CL) Anti-Fouling Compositions

In the 1960's attempts were made to increase the lifetime of anti-fouling compositions by increasing their biocide content. Such highly filled coatings required increased quantities of the film forming resin and plasticizer components for film integrity, at the expense of the Rosin, making the CL coatings hard and almost insoluble in seawater. They became known as “Contact Leaching” anti-fouling compositions as the biocide particles were all in close contact with each other.

The toughness of these compositions means that there is essentially no dissolution or decrease of the paint film thickness over time, and, as more and more biocide is leached out, a thick depleted layer develops at the surface. This layer is referred to as the “Leached Layer”.

As the “leached layer” increases in size, the diffusion of biocides from the depth of the film is reduced meaning that few products of this type have life-times in excess of 24 months (depending on in-service conditions and specification applied).

Self-Polishing Copolymer (SPC) Anti-Fouling Compositions

The SPC anti-fouling compositions release the biocides by a hydrolysis or ion exchange reaction of an acrylic polymer with seawater. This reaction only occurs near the surface, and, unlike the Rosin systems, seawater penetration into the bulk of the film is prevented by the hydrophobic nature of the polymer system.

The fact that the solubility of the polymer coating composition is confined to the surface layer only gives a greatly increased control of release of the biocides since the leached layer of SPC systems is always thin (<30 μm).

The initial leaching rate of the SPC is much lower than that of the CDP systems. A “steady state” constant leaching rate is achieved as the surface reaction continues. This steady state can continue for as long as there is anti-fouling composition left on the ship hull. These characteristics make SPC systems far more efficient as anti-fouling compositions than the rosin-based CDP types.

Hybrid SPC/CDP Systems

Recently developed anti-fouling type is a combination of a hydrolysable TBT-free SPC technology (Copper Acrylate SPC) and a rosin-based CDP technology.

By carefully combining these two technologies to form a “hybrid”, it is possible to produce an anti-fouling composition which has the surface tolerance and desirable volume solids of the CDP systems as well as the benefits from the SPC systems of control of polishing rate and biocide release and a reduced leached layer.

The addition of a hydrolysable polymers (such as e.g. copper acrylate) to the rosin to form such hybrid anti-fouling compositions has been disclosed in WO 00/43640. The performance of the system has been enhanced by the use of a Pyrithione boosting biocide.

The disclosed anti-fouling compositions use an acrylic copolymer, which undergoes hydrolysis or ion exchange in seawater to effect biocide release. These products demonstrate controlled biocide release rates and have a 60 months in-service track record.

Presently, the majority of the above-mentioned anti-fouling paint compositions contain a toxic substance, such as heavy metals, which slowly reacts with e.g. seawater to give a salt soluble in water and which is leached from the matrix of the paint. However, the steady accumulation of these toxic substances in the marine environment has adversely affected marine life. Thus, such toxic substances impose a world-wide pollution risk to the environment and therefore restrictions have been or are being applied to their use and many of them have already been banned in many countries.

Accordingly, there is a need for anti-fouling methods and compositions that do not use toxic additives and harm the environment or impose a health hazard to humans. This need has i.a. resulted in attempts to develop alternative environmentally-friendly and non-polluting anti-fouling methods to overcome the above problems, including the use of enzymes.

U.S. Pat. No. 5,770,188 discloses a self-polishing anti-fouling paint composition containing an enzyme-susceptible resin and a lipid-coated enzyme which is stable in organic solvents as a result of coating the enzyme with a lipid having from 6 to 30 carbon atoms and capable of catalyzing the degradation of said resin.

### SUMMARY OF THE INVENTION

The coating compositions according to the present invention comprise polymers comprising hydrolysable moieties capable of being hydrolysed e.g. by sea water. The hydrolysis is preferably non-enzymatic or at least independent of any enzyme also forming part of the coating composition.

Thus, in a first main aspect, the invention relates to a self-polishing anti-fouling coating composition comprising:
i) a first enzyme having anti-fouling activity, and
ii) at least one hydrolysable polymer composition capable of being non-enzymatically hydrolysed in an aqueous environment.

Hydrolysis of the hydrolysable moieties generates a self-polishing and thus anti-fouling effect. Furthermore, the first enzyme of the coating composition has anti-fouling activity, i.e. it contributes to the anti-fouling effect by acting on fouling organisms, or acting on a substrate, wherein said action results in the generation of a bioactive anti-fouling agent, such as e.g. peroxide.

The hydrolysable moieties of the film forming polymer composition according to the invention are preferably hydrolysed by e.g. sea water and not by the action of an enzyme present in the coating composition. Thus, the invention preferably does not employ an enzyme for hydrolysing a hydrolysable polymer composition in order to achieve a self-polishing effect. However, in one particular embodiment, the composition of the invention comprises a first enzyme having anti-fouling activity, as well as a second enzyme for hydrolysing the hydrolysable polymer composition in order to achieve a self-polishing effect. Thus, in this aspect, the invention relates to a self-polishing anti-fouling coating composition comprising:
i) a first enzyme having anti-fouling activity, and
ii) a second enzyme having polymer-hydrolysing activity, and
iii) at least one hydrolysable polymer composition capable of being hydrolysed by said second enzyme.

In this case, the first enzyme does preferably not contribute to the self-polishing effect. The second enzyme typically does not have a direct anti-fouling activity, i.e. it does not contribute to the generation of anti-fouling species.

Also, the present invention, in preferred embodiments, exploits the use of hydrophilic moieties in the coating composition in order for the coating composition to support and maintain—over prolonged periods of time—the activity of the enzymes in the coating composition.

The prior art does not disclose self-polishing anti-fouling coating compositions comprising hydrolysable moieties and enzymes, wherein the enzymes act solely as anti-fouling agents and do not act in the hydrolysis of the hydrolysable moieties—which hydrolysis is responsible for the self-polishing nature of the coating composition.

The term “fouling” is used herein to designate the attachment of in particular aquatic organisms to the surfaces of structures occasionally or permanently submerged in an aqueous environment, such as bacteria, protozoa, algae and invertebrates including barnacles and mussels.

In one aspect the present invention is directed to coating compositions comprising at least one enzyme and at least one polymer composition comprising a plurality of different types of moieties, such as
i) hydrolysable moieties comprising at least one chemical bond capable of being hydrolysed in an aqueous environment, such as e.g. trimethylsilylmethacrylate moieties, capable of undergoing hydrolysis in a slightly basic, aqueous environment, wherein said hydrolysis represents a first anti-fouling activity of the coating composition resulting in fouling organisms, preferably marine fouling organisms, becoming detached from the coating composition when part of the coating composition becomes solubilised as a result of said hydrolysis,
and/or
ii) hydrophilic moieties contributing to the formation—in the polymer lattice or polymer network—of an environment in which an enzyme can act on a substrate and thereby provide the coating composition with a second anti-fouling activity, wherein said substrate is a fouling organism, preferably a fouling marine organism, or a substrate not forming part of the coating composition, wherein said substrate can be converted—by the action of the enzyme—into an anti-fouling species, such as e.g. peroxide,

and/or

hydrophobic moieties, such as e.g. n-butylmethacrylate, which confer on the coating composition a desirable degree of insolubility in water.

In preferred embodiments, the hydrolysable monomer/moieties make up between 1% and 80% of the total weight of co-polymer, more preferably between 5 and 40%, even more preferably between 10% and 35%, most preferably between 20% and 30%. The hydrophilic monomers/moieties preferably make up between 0.1% and 25% of the total weight of the co-polymer, more preferably between 0.5% and 15%, most preferably between 1% and 10%. The hydrophobic monomers/moieties preferably make up between 5% and 95% of the total weight of the co-polymer, more preferably between 40% and 90%, most preferably between 60% and 85%.

The hydrolysable moieties are in principle optional, but they must be present when the hydrophobic moieties do not comprise hydrolysable bonds the hydrolysis of which results in fouling organisms becoming detached from the coating composition when part of the coating composition becomes solubilised as a result of said hydrolysis.

Without being bound by theory, one presently preferred hypothesis holds that the hydrophilic moieties—in combination with the hydrophobic monomers—provide an environment which is—surprisingly—compatible with enzymatic activity exerted by an enzyme comprised in the coating composition latice or network, while the hydrolysable moieties—when hydrolysed—result in the slow solubility of the coating composition. Accordingly, the “dual action” anti-fouling nature of the coating composition is believed to result from both a) enzyme activity, and b) hydrolysis of hydrolysable moieties.

It is a further objective of the invention to provide a method for preventing fouling of a surface by an aquatic organism by applying to the surface an effective amount of the anti-fouling coating composition according to the invention. It is contemplated that aquatic organisms such as those belonging to the group of bacteria, protozoa, fungi, algae and invertebrates, can be efficiently hindered in attaching to surfaces by applying the method of the present invention.

In one embodiment the organisms which, by the present method, can be efficiently hindered in attaching to a surface are barnacles and mussels. Such barnacles can be of the Cirripedia subclass including Balanus galeatus, Balanus amphitrite, Elminius modestus, Balanus improvisus and Balanus balanoides

There is also provided a method for generating the anti-fouling coating compositions according to the invention.

Definitions

Anti-fouling: The effect of controlling, reducing and/or eliminating over time the number of undesirable microorganisms in a bio-film.

Anti-fouling species: Species such as antimicrobial species, antibacterial species, antifungal species, biocides, biorepellents, and the like.

Bio-film: Habitation of microbial organisms on a solid or semi-solid surface.

Coating composition: Composition for coating an object, such as a paint.

Co-factor: Additional factor required by an enzyme.

Enzyme: Biomolecule comprising a plurality of amino acids and capable of catalysing conversion of substrates into products. The terms enzyme and precursor-degrading enzyme are used interchangeably unless otherwise indicated. A precursor-degrading enzyme is any enzyme capable of degrading a precursor compound thus providing a substrate to another enzyme that can further convert the substrate into an anti-fouling species. Unless specified otherwise, the terms ‘enzyme’, ‘first enzyme’ and ‘precursor-degrading enzyme’ when used herein generally refer to enzymes that contribute to generating an anti-fouling species. An exception to this are the enzymes that have polymer-hydrolysing activity. These latter enzymes do not contribute to the generation of an anti-fouling species, but can hydrolyse the polymer to give a self-polishing effect.

Hydrophilic monomer: a monomer that typically produces as homopolymer a substance that is water-soluble or able to absorb water and/or that has a surface on which water droplets do not readily form beads, but, instead, the water droplets tend to assume a contact angle of less than 90 degrees with the substance.

Lipid or lipid composition: When used herein in connection with modification and/or coating of enzymes, lipid means a compound having a long-chain alkyl group, which is a hydrophobic group, and a hydrophilic group.

Marine organism: Any organism capable of habitating in an aqueous environment, including organisms capable of forming undesirable bio-films.

Microbial organism: Any organism belonging to the classes of prokaryotes and lower eukaryotes, including bacteria, yeasts, fungal cells and slime molds.

Oxidase: Enzyme the activity of which results in an oxidation, including an oxidation resulting in the formation of a peroxide, including hydrogenperoxide.

Peroxide: Product resulting from a reaction involving an oxidase.

Precursor compound: Precursor compounds are capable of being catalysed by a precursor-degrading enzyme, wherein said catalysis results in the formation of a compound capable of being catalysed by an enzyme, typically a different enzyme, under the generation of an anti-fouling species, including e.g. an antimicrobial species having an antimicrobial activity.

Secretion: Process of translocating a compound or precursor compound across the outer membrane of a microbial species. Secretion applies to compounds which remain membrane-associated as well as to compounds which are subsequently released into an external environment.

Surface: Outer part of e.g. a microbial organism in contact with the external environment.

### DESCRIPTION OF THE FIGURES

FIG. 1. Principle self polishing monomer

FIG. 2. % Weight loss per hour of polymer coatings at pH=10 for different ratio's rosin:acrylic polymer

FIG. 3. % Weight loss per hour of polymer coatings at pH=11 for different ratio's rosin:acrylic polymer

FIG. 4. Relative weight of coating versus polishing time at pH=12 for rosin:acrylic polymer=1:1

FIG. 5. Relative weight of coating versus polishing time at pH=12 for rosin:acrylic polymer=3:1

FIG. 6. Enzyme assay results

### DETAILED DESCRIPTION OF THE INVENTION

It is one objective of the present invention to provide environmentally friendly anti-fouling coating compositions comprising enzymes as the active anti-fouling agent. The coating compositions according to the invention thus represent an alternative to conventional biocidal anti-fouling compositions.

The coating composition of the present invention can advantageously be applied to prevent or reduce fouling of a surface by coating the surface with the composition. Such a surface can be any surface of structures that are intermittently or continuously immersed in water, such as the surfaces of vessels including boats and ships. Accordingly, in one specific embodiment of the present invention such surface is a ship hull. However, it is also contemplated that fouling of surfaces of off-shore equipment, pipes, substructures of bridges and piers, aquacultural apparatuses including fish farming nets, can be efficiently reduced or prevented.

The primary objective of the present invention is to provide an anti-fouling coating composition. Thus, there is provided a composition which effectively reduces or prevents fouling of—in particular—marine surfaces coated with the composition according to invention.

The anti-fouling coating composition according to the invention is useful in aqueous environments such as fresh, salt or brackish water, including cooling tower systems, fresh water piping systems, salt water piping systems, ponds, lakes, harbours and desalination systems.

Coating compositions can be in a variety of forms, including paints, lacquers, pastes, laminates, epoxies, resins, waxes, gels, and glues in addition to other forms known to one of skill in the art.

The compositions and/or paints may be polymeric, oligomeric, monomeric, and may contain cross-linkers or cure promoters as needed. Such compositions and/or paints may contain other additives, in addition to those mentioned above, to accomplish purposes known to one of skill in the art. Such other additives include preservatives, pigments, dyes, fillers, surfactants, and other additives known to one of skill in the art.

The coating composition of the present invention can be provided as a ready-for-use product or as a concentrate. The ready-for-use product may be in the form of a solvent based solution, an aqueous solution, aqueous dispersion, oil solution, oil dispersion, emulsion, or an aerosol preparation. The concentrate can be used, for example, as an additive for coating, or can be diluted prior to use with additional solvents or suspending agents. An aerosol preparation according to the invention may be obtained in the usual manner by incorporating the composition of the present invention comprising or dissolved or suspended in, a suitable solvent, in a volatile liquid suitable for use as a propellant.

Polymer Compositions

In one embodiment, the self-polishing anti-fouling coating compositions according to the present invention comprise at least one enzyme and polymers or co-polymers comprising a) at least one copper-free, self-polishing functionality, such as e.g. a polymer comprising a hydrolysable moiety, b) a hydrophilic functionality capable of supporting—in combination with the hydrophobic functionality—enzyme activities over prolonged periods of time, and, in most embodiments, c) a further hydrophobic functionality as the bulk component in order to prevent immediate solvation of the composition in seawater. The coating composition optionally also comprises at least one rosin compound.

The polymer composition of the coating composition can be a composition of co-polymer comprising a) hydrophobic and hydrophilic moieties and/or b) hydrophilic and hydrolysable moieties and/or c) hydrophobic and hydrolysable moieties, or the polymer composition can comprise one or more co-polymers comprising hydrophobic moieties and hydrophilic moieties and hydrolysable moieties.

Without being bound by theory, it is expected that the rate of “self-polishing” can be controlled by the number of hydrolysable and/or hydrophilic moieties in the copolymer, optionally in combination with the amount of rosin compounds present in the coating composition.

The below section discloses preferred functional groups needed for enzyme compatibility and “self-polishing” functionality in the coating compositions according to the invention.

To obtain a “self polishing” effect in the coating composition according to the invention, hydrolysable moieties can be incorporated into a predominantly hydrophobic polymer. The hydrolysable moieties are preferably hydrophobic in their non-hydrolyzed state, but become hydrophilic after hydrolysis.

The term “hydrophobic” monomer or moiety or constituent unit as used herein is preferably a monomer or moiety or constituent unit which cannot undergo non-enzymatic hydrolysis in accordance with the invention.

The term “hydrolysable” monomer or moiety or constituent unit as used herein is a monomer or moiety or constituent unit which can be hydrolysed in an aqueous environment.

Being submerged in (slightly basic) water the hydrolysable moieties will slowly hydrolyse at the interface between the coating composition and the water phase. When sufficient hydrophilic groups have been formed, the polymer chain becomes water-soluble and will dissolve leading to a “self-polishing” effect.

One preferred type of co-polymers are ones comprising silyl-type hydrolysable moieties, such as co-polymers of the silyl(meth)acrylate type described in U.S. Pat. No. 6,458,878. Methods for preparation of these have also been described in U.S. Pat. No. 6,458,878.

For example, a suitable co-polymer (A-1) may comprise:

(a) silyl(meth)acrylate constituent units as defined below,

and, optionally,

(b) acrylic unsaturated monomer constituent units as defined below, and/or (c) unsaturated monomer constituent units other than the constituent units (a) and (b) as defined below.

More specifically, a suitable copolymer (A-1) may comprise:

(a) silyl(meth)acrylate constituent units represented by the following formula (I):

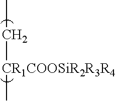

wherein R₁ is a hydrogen atom or a methyl group, and R₂, R₃ and R₄ may be the same or different and are each an alkyl group, a cycloalkyl group or a phenyl group which may have a substituent group.

The number of carbon atoms of the alkyl group is in the range of preferably 1 to 18, more preferably 1 to 6, and the number of carbon atoms of the cycloalkyl group is in the range of preferably 3 to 10, more preferably 3 to 8. Examples of the substituent groups which can be substituted for hydrogen atoms in the phenyl group include alkyl, aryl and halogen.

The silyl(methyl)acrylate, from which the silyl(meth)acrylate constituent unit is derived, is represented by the following formula (I-a).

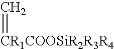

In the formula (I-a), R₁ is the same as R₁ in the formula (I) and is a hydrogen atom or a methyl group. R₂, R₃ and R₄ are the same as R₂, R₃ and R₄ in the formula (I), and they may be the same or different and are each the same alkyl group, cycloalkyl group or phenyl group which may have a substituent group as described above.

Examples of the silyl(meth)acrylates (I-a) include:

silyl(meth)acrylates wherein R₂, R₃ and R₄ are the same as one another, such as trimethylsilyl(meth)acrylate, triethylsilyl(meth)acrylate, tripropylsilyl(meth)acrylate, triisopropylsilyl(meth)acrylate, tributylsilyl(meth)acrylate, tri-sec-butylsilyl(meth)acrylate and triisobutylsilyl(meth)acrylate; and

silyl(meth)acrylates wherein R₂, R₃ and R₄ are partly or entirely different from one another, such as sec-butylmethylsilyl(meth)acrylate, sec-butyldimethylsilyl(meth)acrylate, dimethylpropylsilyl(meth)acrylate, monomethyldipropylsilyl(meth)acrylate and methylethylpropylsilyl(meth)acrylate.

Silyl(meth)acrylates can be used singly or in combination of two or more kinds. Of such silyl(meth)acrylates, preferable are those wherein R₂, R₃ and R₄ are each independently an alkyl group of about 1 to 18 carbon atoms, such as methyl, ethyl, n-propyl, isopropyl, sec-butyl, tert-butyl or isobutyl, and more preferable are those wherein at least one of alkyl groups indicated by R₂, R₃ and R₄ has 3 or more carbon atoms. Also preferable are those wherein the total number of the carbon atoms in R₂, R₃ and R₄ is in the range of about 5 to 21. Of such silyl(meth)acrylates, triisopropylsilyl(meth)acrylate, triisobutylsilyl(meth)acrylate, disec-butylmethylsilyl(meth)acrylate, sec-butyldimethylsilyl(meth)acrylate and tri-sec-butylsilyl(meth)acrylate are most preferably used in consideration of ease of synthesis of the silyl(meth)acrylate copolymer and film-forming properties, storage stability and polishing-cleaning controllability of an antifouling paint composition using the silyl(meth)acrylate copolymer.

Methods for preparation of co-polymers comprising these silyl(meth)acrylate constituent units have been described in U.S. Pat. No. 6,458,878.

In addition, a suitable copolymer (A-1) may comprise:

(b) acrylic unsaturated monomer constituent units represented by the following formula (II):

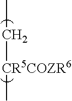

wherein R⁵ is a hydrogen atom or a methyl group, and Z is an oxygen atom or —NR⁷.

When Z is an oxygen atom, R⁶ is a hydroxyalkyl or hydroxycycloalkyl group which may have a substituent group or a polyalkylene glycol group represented by the formula —(R⁸O)ₙH (wherein R⁸ is an alkylene group and n is an integer of 2 to 50).

The number of carbon atoms of the hydroxyalkyl group in the formula (II) is in the range of preferably 1 to 18, more preferably 2 to 9, the number of carbon atoms of the hydroxycycloalkyl group is in the range of preferably 3 to 10, more preferably 3 to 8, and the number of carbon atoms of the polyalkylene glycol group is in the range of preferably 1 to 8, more preferably 2 to 4.

When Z is —NR⁷, R⁷ is an alkyl group which may be substituted with any of a halogen, a hydroxyl group, an amino group, a substituted amino group, an acyl group and an alkoxy group, and R⁶ is a hydrogen atom.

The unsaturated monomer, from which the unsaturated monomer constituent unit (b) is derived, is represented by the following formula (II-a).

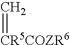

In the formula (II-a), R⁵ is the same as R⁵ in the formula (II) and is a hydrogen atom or a methyl group, and Z is the same as Z in the formula (II) and is an oxygen atom or —NR⁷.

When Z is an oxygen atom, R⁶ is a hydroxyalkyl or hydroxycycloalkyl group which may have a substituent group or a polyalkylene glycol group represented by the following formula:
—(R⁸O)ₙH

wherein R⁸ is an alkylene group, and n is an integer of 2 to 50.

The number of carbon atoms of the hydroxyalkyl group in the formula (II-a) is in the range of preferably 1 to 18, more preferably 2 to 9, the number of carbon atoms of the hydroxycycloalkyl group is in the range of preferably 3 to 10, more preferably 3 to 8, and the number of carbon atoms of the polyalkylene glycol group is in the range of preferably 1 to 8, more preferably 2 to 4.

When Z is —NR⁷, R⁷ is an alkyl group which may be substituted with any of a halogen, a hydroxyl group, an amino group, a substituted amino group, an acyl group and an alkoxy group, and R⁶ is a hydrogen atom.

Examples of the unsaturated monomers (II-a) represented by the formula (II-a) wherein Z is an oxygen atom include 2-hydroxyethyl acrylate, 2-hydroxyethyl methacrylate, 2-hydroxypropyl acrylate, 2-hydroxypropyl methacrylate, 3-chloro-2-hydroxypropyl methacrylate, 3-phenoxy-2-hydroxypropyl acrylate, 4-hydroxybutyl acrylate, 2-hydroxybutyl acrylate, 2-hydroxybutyl methacrylate, 6-hydroxyhexyl acrylate, 1,4-hydroxyhexanedimethanol monoacrylate, polyethylene glycol monomethacrylate (n=2), polyethylene glycol monomethacrylate (n=4), polyethylene glycol monomethacrylate (n=5), polyethylene glycol monomethacrylate (n=8), polyethylene glycol monomethacrylate (n=80), polyethylene glycol monomethacrylate (n=15), polypropylene glycol monomethacrylate (n=5), polypropylene glycol monomethacrylate (n=9) and polypropylene glycol monomethacrylate (n=12).

Examples of the unsaturated monomers (II-a) represented by the formula (II-a) wherein Z is —NR⁷ include N-methylol acrylamide, N-methoxymethyl acrylamide, N-ethoxymethyl acrylamide, N,N-dimethylaminopropyl acrylamide, N,N-dimethylaminopropyl methacrylamide and diacetone acrylamide.

These unsaturated monomers (II-a) can be used singly or in combination of two or more kinds. Methods for preparation of co-polymers comprising these unsaturated monomers have been described in U.S. Pat. No. 6,458,878.

Of the unsaturated monomers (II-a), hydroxyl group-containing monomers are preferable. Of the hydroxyl group-containing monomers, 2-hydroxyethyl methacrylate, 2-hydroxypropyl acrylate and 2-hydroxybutyl methacrylate are preferably used, because an antifouling coating film having proper elution properties can be obtained.

In addition, a suitable copolymer (A-1) may comprise:

(c) unsaturated monomer constituent units other than the constituent units (a) and (b).

Examples of the unsaturated monomers (c1), from which the unsaturated constituent unit (c) can be derived, include (meth)acrylic esters, such as methyl(meth)acrylate, ethyl(meth)acrylate, butyl(meth)acrylate and octyl(meth)acrylate; styrenes, such as styrene, vinyltoluene and alpha-methylstyene; vinyl esters, such as vinyl acetate, vinyl benzoate, vinyl propionate and vinyl butyrate; crotonic esters; itaconic esters; fumaric esters; and maleic esters. Of these, (meth)acrylic esters, styrenes and vinyl esters are preferably used, because an antifouling coating film having proper strength of coating film can be obtained.

In a preferred embodiment, the unsaturated monomer constituent units (c) are those derived from at least one compound selected from (meth)acrylic esters, styrene and vinyl esters.

These unsaturated monomers are used singly or in combination of two or more kinds. Methods for preparation of co-polymers comprising these unsaturated monomers have been described in U.S. Pat. No. 6,458,878.

In the silyl(meth)acrylate copolymer of the invention, the silyl(meth)acrylate constituent units (a) are preferably contained in amounts of 10 to 80% by weight, more preferably 20 to 70% by weight, the acrylic unsaturated monomer constituent units (b) are preferably contained in amounts of 0.01 to 40% by weight, more preferably 0.1 to 20% by weight, and the unsaturated monomer constituent units (c) are preferably contained in amounts of 5 to 79.99% by weight, more preferably 10 to 60% by weight.

The weight-average molecular weight of the silyl(meth)acrylate copolymer (A-1), as measured by gel permeation chromatography (GPC), is desired to be not more than 200,000, preferably 5,000 to 100,000, from the viewpoints of ease of preparation of an antifouling paint containing the silyl(meth)acrylate copolymer (A-1), painting workability of the resulting antifouling paint, consumption rate of an antifouling coating film, and crack resistance of the coating film.

As another example, the composition may comprise a silyl(meth)acrylate copolymer (A-2) comprising:

silyl(meth)acrylate constituent units as defined below under (d),

and/or

silyl(meth)acrylate constituent units as defined below under (e),

and, optionally, unsaturated monomer constituent units other than the constituent units (d) and (e) as defined below under (f).

Methods for preparation of these co-polymers (A-2) have been described in U.S. Pat. No. 6,458,878.

More specifically, a suitable copolymer (A-2) may comprise:

(d) silyl(meth)acrylate constituent units represented by the following formula (III):
—CH₂—CR(COOSiR¹¹R¹²R¹³) (III)

wherein R is a hydrogen atom or a methyl group, R¹¹ and R¹² are each independently a straight-chain alkyl group of 1 to 10 carbon atoms, a phenyl group which may have a substituent group or a trimethylsilyloxy group, and R¹³ is an alkyl group of 1 to 18 carbon atoms which may have a cyclic structure or a branch, a phenyl group of 6 to 10 carbon atoms which may have a substituent group or a trimethylsilyloxy group,

Examples of the straight-chain alkyl groups include methyl, ethyl, n-propyl, n-butyl, n-pentyl, n-hexyl, n-heptyl, n-octyl, n-nonyl and n-decyl.

Examples of the substituent groups which can be substituted for hydrogen atoms in the phenyl group include alkyl, aryl and halogen.

R¹³ is an alkyl group of 1 to 18 carbon atoms, preferably 1 to 12 carbon atoms, more preferably 1 to 9 carbon atoms, which may have a cyclic structure or a branch, a phenyl group of 6 to 10 carbon atoms, preferably 6 to 8 carbon atoms, which may have a substituent group, or a trimethylsilyloxy group represented by (CH₃)₃SiO—.

Examples of the alkyl groups include:

the straight-chain alkyl groups exemplified above;

branched alkyl groups, such as isopropyl, isobutyl, sec-butyl, tert-butyl and neopentyl; and

alicyclic alkyl groups having alicyclic structure (cyclohexane ring, norbornan ring), such as cyclohexyl and ethylidenenorbornyl.

Although R¹¹, R¹² and R¹³ may be the same or different, they are each preferably methyl, ethyl, n-propyl, n-butyl, n-hexyl or trimethylsilyloxy, and particularly preferably methyl, n-propyl, n-butyl and n-hexyl.

The silyl(meth)acrylate (dl), from which the silyl(meth)acrylate constituent unit (d) is derived, is represented by the following formula (III-d).
CH₂═CR(COOSiR¹¹R¹²R¹³)

In the formula (III-d), R is the same as R in the formula (III) and is a hydrogen atom or a methyl group, R¹¹ and R¹² are the same as R¹¹ and R¹² in the formula (III) and are each independently a straight-chain alkyl group of 1 to 10 carbon atoms, a phenyl group which may have a substituent group or a trimethylsilyloxy group, and R¹³ is the same as R¹³ in the formula (III) and is an alkyl group of 1 to 18 carbon atoms which may have a cyclic structure or a branch, a phenyl group of 6 to 10 carbon atoms which may have a substituent group or a trimethylsilyloxy group.

Examples of the silyl (meth)acrylates (III-d) include:

aliphatic silyl(meth)acrylates wherein R¹¹, R¹² and R¹³ are the same as one another, such as trimethylsilyl(meth)acrylate, triethylsilyl(meth)acrylate, tri-n-propylsilyl(meth)acrylate, tri-n-butylsilyl(meth)acrylate, tri-n-pentylsilyl(meth)acrylate, tri-n-hexylsilyl(meth)acrylate, tri-n-heptylsilyl(meth)acrylate, tri-n-octylsilyl(meth)acrylate, tri-n-nonylsilyl(meth)acrylate and tri-n-decylsilyl(meth)acrylate;

aromatic or siloxane type silyl(meth)acrylates wherein R¹¹, R¹² and R¹³ are the same as one another, such as triphenylsilyl(meth)acrylate and tris(trimethylsilyloxy)silyl(meth)acrylate; and

aliphatic silyl(meth)acrylates wherein R¹¹, R¹² and R¹³ are partly or entirely different from one another, such as dimethyl-n-propylsilyl(meth)acrylate, isopropyldimethylsilyl(meth)acrylate, di-n-butyl-isobutylsilyl(meth)acrylate, n-hexyldimethylsilyl(meth)acrylate, sec-butyldimethylsilyl(meth)acrylate, monomethyl-di-n-propylsilyl(meth)acrylate, methylethyl-n-propylsilyl(meth)acrylate, ethylidenenorbornyldimethylsilyl(meth)acrylate, trimethylsilyloxydimethylsilyl(meth)acrylate (CH₂═C(CH₃)COOSi(CH₃)2(OSi(CH₃)₃), and CH₂═CHCOOSi(CH₃)₂(OSi(CH₃)₃)).

In the present invention, such silyl(meth)acrylates (III-d) can be used singly or in combination of two or more kinds.

In addition, a suitable copolymer (A-2) may comprise:

(e) silyl(meth)acrylate constituent units represented by the following formula (IV):
—CH₂—CR(COOSiR¹⁴R¹⁵R¹⁶) (IV)

In the formula (IV), R is a hydrogen atom or a methyl group, and R¹⁴ and R¹⁵ are each independently a branched alkyl group of 3 to 10 carbon atoms, preferably 3 to 8 carbon atoms, or a cycloalkyl group of 3 to 10 carbon atoms, preferably 3 to 9 carbon atoms.

Examples of the branched alkyl groups include the same ones as in the formula (III), such as isopropyl, isobutyl, sec-butyl, tert-butyl, and neopentyl. Examples of the cycloalkyl groups include cyclohexyl and ethylidenenorbornyl.

R¹⁶ is a straight-chain alkyl group of 1 to 10 carbon atoms, preferably 1 to 8 carbon atoms, more preferably 1 to 6 carbon atoms, a branched alkyl or cycloalkyl group of 3 to 10 carbon atoms, preferably 3 to 9 carbon atoms, a phenyl group of 6 to 10 carbon atoms, preferably 6 to 8 carbon atoms, which may have a substituent group, or a trimethylsilyloxy group.

Examples of the straight-chain alkyl groups, the branched alkyl or cycloalkyl groups and the phenyl groups of R¹⁵ include the same groups as described above.

R¹⁴, R¹⁵ and R¹⁶ may be the same or different. When they are the same, they are preferably isopropyl, sec-butyl or isobutyl, particularly preferably isopropyl or sec-butyl. When R¹⁴, R¹⁵ and R¹⁶ are partly or entirely different, R¹⁴ and R¹⁵ are each preferably isopropyl, isobutyl, sec-butyl or tert-butyl although they may be the same or different, and R¹⁶ is preferably methyl, ethyl, propyl, isopropyl, n-butyl, isobutyl or trimethylsilyloxy.

The silyl(meth)acrylate (e1), from which the silyl(meth)acrylate constituent unit (e) is derived, is represented by the following formula (IV-e).
CH₂═CR(COOSiR¹⁴R¹⁵R¹⁶) (IV-e)

In the formula (IV-e), R is the same as R in the formula (IV) and is a hydrogen atom or a methyl group, R¹⁴ and R¹⁵ are the same as R¹⁴ and R¹⁵ in the formula (IV) and are each independently a branched alkyl group of 3 to 10 carbon atoms or a cycloalkyl group of 3 to 10 carbon atoms, and R¹⁶ is the same as R¹⁶ in the formula (IV) and is a straight-chain alkyl group of 1 to 10 carbon atoms, a branched alkyl or cycloalkyl group of 3 to 10 carbon atoms, a phenyl group of 6 to 10 carbon atoms which may have a substituent group or a trimethylsilyloxy group.

Examples of the silyl(meth)acrylates (IV-e) include:

silyl(meth)acrylates wherein R¹⁴, R¹⁵ and R¹⁶ are the same as one another, such as triisopropylsilyl(meth)acrylate, triisobutylsilyl(meth)acrylate and tri-sec-butylsilyl(meth)acrylate; and

silyl(meth)acrylates wherein R¹⁴, R¹⁵ and R¹⁶ are partly or entirely different from one another, such as diisopropylcyclohexylsilyl(meth)acrylate, diisopropylphenylsilyl(meth)acrylate, diisopropyltrimethylsiloxysilyl(meth)acrylate, di-sec-butylmethylsilyl(meth)acrylate, di-sec-butylethylsilyl(meth)acrylate, di-sec-butyltrimethylsilyloxysilyl(meth)acrylate and isopropyl-sec-butylmethylsilyl(meth)acrylate.

In the present invention, such silyl(meth)acrylates (IV-e) can be used singly or in combination of two or more kinds.

When ease of synthesis of the silyl(meth)acrylate copolymer and film-forming properties, storage stability and polishing-cleaning controllability of an antifouling paint composition using the silyl(meth)acrylate copolymer are taken into consideration, of such silyl(meth)acrylate, it is preferable to use a combination of at least one compound selected from trimethylsilyl(meth)acrylate, triethylsilyl(meth)acrylate, tri-n-propylsilyl(meth)acrylate, tri-n-butylsilyl(meth)acrylate, n-hexyldimethylsilyl(meth)acrylate, n-octyldimethylsilyl(meth)acrylate, isopropyldimethylsilyl(meth)acrylate, ethylidenenorbornyldimethylsilyl(meth)acrylate, trimethylsilyloxydimethylsilyl(meth)acrylate, bis(trimethylsilyloxy)methylsilyl(meth)acrylate and tris(trimethylsilyloxy)silyl(meth)acrylate as the silyl(meth)acrylate (III-d) and at least one compound selected from triisopropylsilyl(meth)acrylate, triisobutylsilyl(meth)acrylate, tri-sec-butylsilyl(meth)acrylate, di-sec-butylmethylsilyl meth)acrylate, di-isopropyltrimethylsilyloxysilyl(meth)acrylate and di-sec-butyltrimethylsilyloxysilyl(meth)acrylate as the silyl(meth)acrylate (IV-e). It is more preferable to use a combination of tri-n-butylsilyl(meth)acrylate as the silyl(meth)acrylate (III-d) and triisopropylsilyl(meth)acrylate as the silyl(meth)acrylate (IV-e).

In addition, a suitable copolymer (A-2) may comprise:

(f) unsaturated monomer constituent units other than the constituent units (d) and (e).

The unsaturated monomer constituent unit (f) constitutes the silyl(meth)acrylate copolymer of the invention together with the constituent units (d) and (e), and is different from any of the constituent units (d) and (e).

Examples of the unsaturated monomers (fl) from which the unsaturated constituent unit (f) can be derived include:

hydrophobic (meth)acrylic esters, such as methyl (meth)acrylate, ethyl (meth)acrylate, n-, iso-, or tert-butyl (meth)acrylate, 2-ethylhexyl (meth)acrylate and cyclohexyl (meth)acrylate;

hydrophilic (meth)acrylic esters, such as 2-hydroxyethyl(meth)acrylate, 2-hydroxypropyl(meth)acrylate, 2-hydroxybutyl(meth)acrylate, 4-hydroxybutyl(meth)acrylate, 2-methoxyethyl(meth)acrylate, methylpolyoxyethylene(meth)acrylate and methylpolyoxypropylene(meth)acrylate;

styrenes, such as styrene, vinyltoluene and alpha-methylstyrene;

vinyl esters, such as vinyl acetate, vinyl benzoate, vinyl propionate and vinyl butyrate; and

organic carboxylic esters, such as itaconic esters and maleic esters.

Of these, preferable are (meth)acrylic esters, styrenes and vinyl esters of organic carboxylic acids because an antifouling coating film having proper strength of coating film can be obtained.

When the hydrophilic (meth)acrylic esters are used, degree of consumption of the coating film can be increased. For this purpose, comonomers having hydrophilic nature, such as acrylamide derivatives, are also employable.

These unsaturated monomers (fl) are used singly or in combination of two or more kinds.

In the silyl(meth)acrylate copolymer, the silyl(meth)acrylate constituent units (d) are desirably contained in amounts of 0.5 to 50% by weight, preferably 0.5 to 25% by weight, the silyl(meth)acrylate constituent units (e) are desirably contained in amounts of 10 to 70% by weight, preferably 30 to 65% by weight, and the unsaturated monomer constituent units (f) other than the constituent units (d) and (e) are desirably contained in amounts of 20 to 70% by weight, preferably 30 to 60% by weight.

The weight-average molecular weight of the silyl(meth)acrylate copolymer (A-2), as measured by gel permeation chromatography (GPC), is desired to be not more than 200,000, preferably 3,000 to 100,000, particularly preferably 5,000 to 50,000, from the viewpoints of ease of preparation of an antifouling paint containing the silyl (meth)acrylate copolymer, painting workability of the resulting antifouling paint, consumption rate of an antifouling coating film, and crack resistance.

In the second silyl(meth)acrylate copolymer (A-2), it is preferable that R¹¹, R¹² and R¹³ are each independently methyl, ethyl, n-propyl, n-butyl, n-hexyl or trimethylsilyloxy. Furthermore, in the second silyl(meth)acrylate copolymer (A-2), it is preferable that R¹⁴, R¹⁵ and R¹⁶ are each independently isopropyl, sec-butyl, tert-butyl or isobutyl. The unsaturated monomer constituent units (f) are preferably those derived from at least one compound selected from (meth)acrylic esters, styrene and vinyl esters of organic carboxylic acids.

For example, one preferred hydrolysable monomer can be illustrated as:

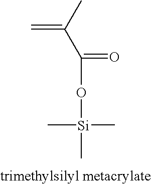

When co-polymerized this moiety can undergo hydrolysis upon contact with (basic) water. The hydrolysis results in the formation of carboxylic acid moieties along the polymer chain.

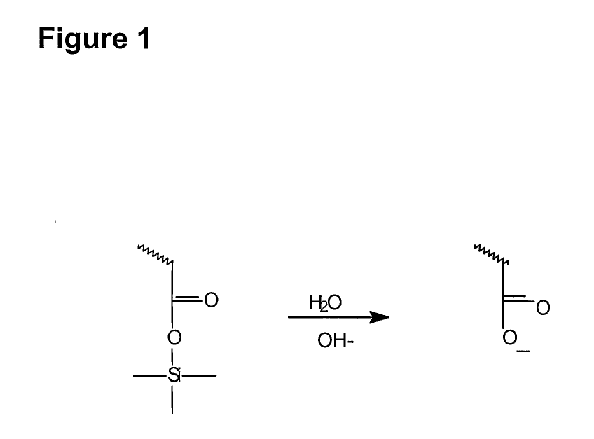

The principle of hydrolysis of the self-polishing moiety is illustrated in FIG. 1.

In the below examples the synthesis of several ter-polymers with n-butyl methacrylate (hydrophobic moiety), trimethylsilyl methacrylate (hydrolysable moiety) and different hydrophilic moieties is described. The examples should not be understood as a limitation of the invention to the examplified ter-polymers.

Other Suitable Self-Polishing Compositions

Other suitable self polishing resins for use in anti-fouling compositions of the invention include the polyester resins described in U.S. Pat. No. 6,395,866. Thus, the coating composition may comprise a structural unit of the formula (z):

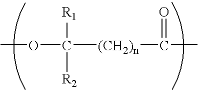

wherein R₁ is H or alkyl having 1 to 3 carbon atoms, R₂ is H or methyl and n is an integer of 0-4, in a proportion of not less than 90 mol % and a metal in the main chain at a concentration of 10-300 eq/10⁶ g, and which has an acid value of 20-1000 eq/10⁶ g, wherein the structural unit of the formula (z) preferably comprises a lactic acid residue in a proportion of not less than 80 mol %, and the lactic acid residue has a molar ration of an L-lactic acid residue to a D-lactic acid residue (L-lactic acid residue/D-lactic acid residue) of 1 to 9.

With regard to the structural unit of the formula, the alkyl having 1 to 3 carbon atoms, which is represented by R₁, is, for example, methyl, ethyl, n-propyl, isopropyl and the like. Examples of the structural unit of the formula (z) include lactic acid residue, glycolic acid residue, 2-hydroxyisobutyric acid residue, 3-hydroxyisobutyric acid residue, 4-hydroxyvaleric acid residue and the like.

Thus, the polyester resin for an antifouling paint can be an aliphatic polyester containing, as the main ingredient (not less than 90 mol %), at least one unit selected from the above-mentioned units. Examples thereof include poly(lactic acid), poly(glycolic acid), poly(2-hydroxyisobutyric acid), poly(3-hydroxyisobutyric acid), poly(4-hydroxyvaleric acid), and an aliphatic polyester containing, as the main ingredient, a copolymer containing two or more kinds of the units selected from the above-mentioned units. These aliphatic polyesters can undergo hydrolysis (inclusive of biodegradation) in the seawater.

When a structural unit other than those represented by the formula (z) is contained, the other structural unit may be, for example, a unit derived from an aliphatic oxycarboxylic acid other than those represented by the formula (z), an ester unit containing aliphatic diol residue and aliphatic dicarboxylic acid residue, and the like. Specific examples of the aliphatic dicarboxylic acid residue include oxalic acid residue, succinic acid residue, adipic acid residue, glutaric acid residue and the like, and examples of the aliphatic diol residue include ethylene glycol residue, propylene glycol residue, trimethylene glycol residue, 1,3-butanediol residue, 1,4-butanediol residue and the like.

Alternatively, the metal ion in the above resin may be replaced by a diamine. Preferred diamines are members of the so-called ‘Jeffamine’ series. This series of commercially available (Huntsman) di- or polyfunctional amines is commonly based on oligo- or poly(ethylene glycol) or propylene glycol platforms, covering a wide range of molecular weights, which are indicated in their code names (e.g. Jeffamine EDR-148 (XTJ-504, triethyleneglycodiamine or 3,6-dioxa-octamethylenediamine CAS 929-59-9) has a molecular weight of 148 g/mol). It is known that a substantial amount of the relatively flexible ethylene glycol units has a plasticizing effect on the eventual coating. For this reason it is preferred to use small Jeffamines for the properties of the coating to be mainly determined by the polyester fraction. The preparation of compositions comprising diamines is described in the Examples. In the case of Jeffamine-containing resins, the self-polishing effect can be achieved through solvation of the ammonium and carboxylate ions in the backbone and/or through hydrolysis of ester groups in the backbone. Thus, ‘hydrolysable’ in this context also includes solvation.

Hydrophylic Moieties

Presently highly preferred hydrophilic moieties of the co-polymer comprised within the coating composition of the invention are selected from the group consisting of pyrolidinones, such as e.g. 1-vinyl-2-pyrolidinone; methacrylates such as e.g. poly(ethyleneglycol-methylether)-methacrylate; hydroxy-ethylmethacrylates; phosphate methacrylates, such as e.g. poly(ethyleneglycol)phosphatemethacrylate; and methacryloyl compounds such as e.g. [2-(methacryloylamino)ethyl]-dimethyl-(3-sulfopropyl)ammoniumhydroxide.

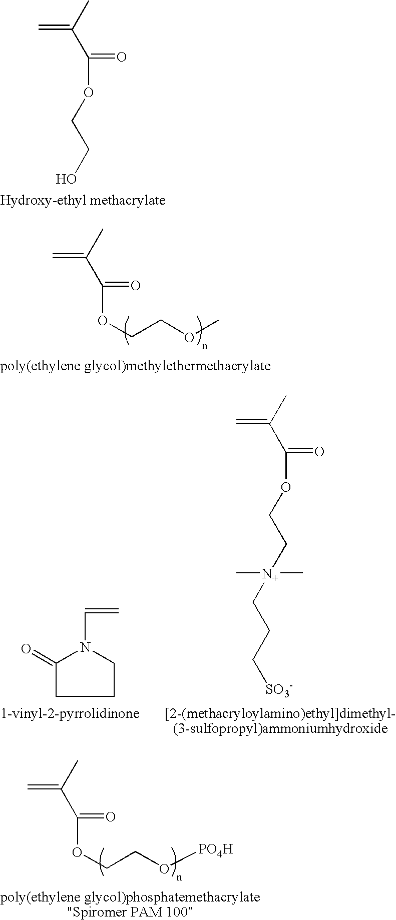

Hydrophilic monomers can be incorporated, e.g. through radical co-polymerization, into an otherwise predominantly hydrophobic coating composition. The hydrophilic moieties in the resulting co-polymer make the coating composition more compatible with the enzymes to be used.

Enzyme-Susceptible Resins

In one particular embodiment, the invention relates to a self-polishing anti-fouling coating composition, comprising
i) a first enzyme having anti-fouling activity,
ii) a second enzyme having polymer-hydrolysing activity, and
iii) at least one hydrolysable polymer composition capable of being hydrolysed by said second enzyme.

In this embodiment, the hydrolysis that gives rise to the self-polishing effect is enzyme-catalyzed. This is in contrast to the previously described embodiments, in which the hydrolysis was non-enzymatic. Enzyme-catalyzed hydrolysis is achieved by the combination of an enzyme-susceptible resin with an enzyme capable of hydrolyzing said enzyme-susceptible resin. Said second enzyme may be any type of enzyme, e.g. a lipase.

The enzyme capable of hydrolyzing said enzyme-susceptible resin, i.e. the ‘second’ enzyme, may be an enzyme which is stable in organic solvents as a result of coating the enzyme with a lipid having from 6 to 30 carbon atoms, such as described in U.S. Pat. No. 5,770,188. Said lipid may contain a hydrophilic moiety selected from the group consisting of sugar residues, phosphoric acid groups, sulfonic acid groups and ammonium salt groups. Preparation of these resins has been described in U.S. Pat. No. 5,770,188. In one embodiment, the lipid is a glucoxide derivative represented by the following general formula:

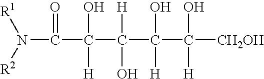

wherein R¹ and R² each independently represent a hydrocarbon group having 6 to 20 carbon atoms. Compositions comprising enzyme-susceptible resins may furthermore comprise hydrophilic moieties as described above to improve compatibility between the enzymes and the resin.

In preferred embodiments, the first enzyme is not lipid-coated and the second enzyme having polymer-hydrolysing activity is lipid-coated.

Enzymes

The anti-fouling coating composition according to the invention comprises a first enzyme having anti-fouling activity which is present in an effective amount to further reduce or prevent fouling of a surface coated with the composition.

Preferably, the first enzyme is not capable of catalysing the hydrolysis of the polymer composition. In one embodiment, the first enzyme is not coated with a lipid composition. In other embodiments, the first enzyme is not covalently immobilised onto the polymer composition. Further embodiments includes ones wherein the first enzyme is neither coated with a lipid composition nor covalently immobilised onto the polymer composition.

In one embodiment of the invention, the first enzyme is selected from the group consisting of a proteolytically active enzyme, a hemicellulolytically active enzyme, a cellulolytically active enzyme, a lipolytically active enzyme and an amylolytically active enzyme.

In the present context “proteolytically active” relates to any enzyme having the capability to degrade proteins. “Hemicellulolytically active” relates to any enzymes such as xylanases, having the capability to degrade at least one substance belonging to the group of compounds generally referred to as hemicellulose including xylans and mannans such as Endo-1,4-beta-xylanase (E.C. 3.2.1.8), Xylan endo-1,3-beta-xylosidase (E.C. 3.2.1.32). Glucuronoarabinoxylan endo-1,4-beta-xylanase (E.C. 3.2.1.136), Beta-mannosidase (E.C. 3.2.1.25), Mannan endo-1,4-beta-mannosidase (E.C. 3.2.1.78) and Mannan endo-1,6-beta-mannosidase (E.C. 3.2.1.101).

Enzymes having “cellulolytic activity” are also generally referred to as cellulases and is used herein to designate any cellulose-hydrolysing enzyme.

“Lipolytically active” enzymes are also generally referred to as lipases and are used herein to designate any triacylglycerol hydrolysing enzyme, including such enzymes that are capable of splitting of fatty acids having short, medium and long chain lengths. Other enzymes having lipolytic activity which are encompassed by the present invention include phospholipases, lysophospholipases, acylglycerol lipases and galactolipases.

“Amylolytically active” enzymes include, in the present context, amylases, such as α- and β-amylases, amyloglucosidases, pullulanases, α-1,6-endoglucanases, α-1,4-exoglucanases and isoamylases.

In a one aspect of the invention the first enzyme is a protease, such as an endopeptidase. Preferred classes of proteases include serine proteases, cysteine roteases, metalloproteases and aspartic proteases. The most preferred type of proteases is the family of serine proteases, for example the endopeptidase Subtilisin (EC 3.4.21.62). The beneficial anti-fouling effect of the protease is believed to be due to the capability of the protease to degrade proteinaceous materials secreted by e.g. barnacles as adhesives for settlement.

In accordance with the invention the endopeptidase Subtilisin (EC 3.4.21.62) can advantageously be used by applying a commercially available enzyme preparation such as Alcalase®. In a presently preferred embodiment the enzyme preparation Alcalase 2.5 L, Type DX® is applied. However it is also contemplated that other Alcalase® products, including Alcalase 2.0 T®, Alcalase 3.0 T® and Alcalase 2.5 L, Type DX®, can be applied in accordance with the present invention. Such Alcalase® enzyme preparations are available from Novozymes (Novozymes, Novo Allé, 2880 Bagsvaerd, Denmark). Alcalase® is a serine-type protease characterised by a good performance at elevated temperatures and moderate alkalinity. Further information with respect to e.g. activity characteristics of the various Alcalase-products is described in the product sheet from Novozymes A/S (B259f-GB).

However, it is also within the scope of the invention that other proteases having essentially the same characteristics as the protease of Alcalase® can be successfully applied in accordance with the invention. Thus, it is contemplated that other proteases, such as subtilisins, having essentially the same temperature and pH profiles as the Alcalase, can be utilised. The temperature and pH profiles of the Alcalase can be found on the product sheet from Novozymes A/S (B259f-GB). Accordingly, it is within the scope of the invention that a subtilisin (EC 3.4.21.62) having the following characteristics: (i) optimum activity at a pH in the range of about 7-10, and (ii) optimum activity at a temperature in the range of about 55-65° C., may advantageously be applied.

Further preferred serine proteases include Savinase 16L Type EX, Esperase 8L, and NS-44128 concentrate.

Additionally, it is also with in the scope of the invention that more than one protease can be applied, e.g. by the use of complex enzyme preparations comprising several proteases.

The enzyme comprised in the coating composition can be any one or more of a purified enzyme or a crude enzyme. The source of the enzyme includes microorganisms, plants, and animals. When incorporating an enzyme into the coating composition, the enzyme may be directly incorporated, or it can be incorporated after modification with another species, or in the form of an entrapped enzyme, i.e. contained in micelles, enzymes modified with or coated with lipids or surfactants; enzymes modified with polyethylene glycol; and enzymes immobilized on polymer matrices, among other forms.

As mentioned above, the composition according to the invention may advantageously comprise one or more enzymes. It has been found by the present inventors that by combining a protease such as a subtilisin, with an amyloglucosidase and/or a xylanase an additional anti-fouling effect was obtained. Thus, it was found that coating compositions comprising a protease in combination with an amyloglucosidase and/or a xylanase reduced or prevented the fouling with algae of a surface submerged in sea water.

Thus, in one useful embodiment, the composition according to the invention comprises an amyloglucosidase (Glucan 1,4-alpha-glucosidase; E.C. 3.2.1.3) such as AMG 300 L, Novozymes A/S, Denmark, optionally in combination with a protease. Other preferred amylases include alpha-amylases such as Temamyl 120L Type S and Fungamyl 800L. In a further useful embodiment, the composition according to the invention comprises a xylanase such as endo-1,4-beta-xylanase (E.C. 3.2.1.8), optionally in combination with a protease. A useful example of such endo-1,4-beta-xylanase (E.C. 3.2.1.8) is the commercially available Pulpzyme HC, Novozymes A/S, Denmark.

Other preferred enzymes for use in the invention comprise Energex L (endo-1,3(4)-beta-glucanase), Viscozyme L (multi-enzyme complex), Glucanex 200G (exo-1,3-beta-glucanase), and Shearzyme Plus (xylanase, glucanase, culluase).

A further example of a preferred enzyme in accordance with the present invention is an oxidase. Accordingly, the present invention in one preferred embodiment relates to a coating composition comprising a hydrolysable polymer composition as described herein above and at least one enzyme, preferably an oxidase, capable of acting on a compound, such as a substrate for said oxidase, wherein said action results in the formation of an anti-fouling species e. g. an antimicrobial species comprising an antimicrobial activity, and wherein said compound preferably does not form part of said coating composition.

In a more preferred embodiment the enzyme is an oxidase the activity of which results in the formation of a peroxide.

The oxidase can be present in said coating composition in combination with one or more additional enzymes including, but not limited to, an esterase, including a lipase, an amidase, a protease, and a polysaccharide-degrading enzyme, wherein said one or more additional enzyme(s), alone or in any combination, can be included in the presence or absence of one or more substrates for one or more of said enzymes.

The anti-fouling species comprising an anti-fouling activity is preferably generated when the first enzyme acts on a compound secreted by a microbial organism. The compound can be a degradation product of a precursor compound, including a polymer located on the surface of microbial organisms, wherein said degradation product is provided by a precursor-degrading enzyme acting on said precursor compound.

The anti-fouling species of the invention having anti-foulant activity can be any species capable of being produced as the result of an enzyme-substrate reaction. As such, there can be mentioned many species having anti-fouling activity, species having antibacterial/antifungal activity, species having biocidal activity, and species having bio-repellent activity, etc.

The species having antimicrobial activity is thus produced by an enzymatic reaction between an enzyme and a substrate in the form of a compound which is preferably secreted by a microbial organism. Species having antimicrobial activity can be any species obtained as the direct result of enzymatic reaction between the enzyme and the compound, as well as any species formed from the product of such enzymatic reaction through further enzymatic and/or chemical reaction.

The compounds are not limited to microbial secretion products. The compounds of the invention can be any non-toxic compound supplied to a predetermined environment, such as a dock harbouring a ship hull, and capable of being converted into an anti-fouling species, including an antimicrobial species by the action of the enzyme, including an oxidase.

Furthermore, it is also envisaged that anti-fouling species, including an antimicrobial species, can be generated by a combination of i) enzymatic action on secreted microbial products, including polymers and degradation products thereof, and ii) enzymatic action on exogenously added compounds or precursor compounds, wherein said combination of enzymatic actions results in the formation of one or more anti-fouling species, including an antimicrobial species having an antimicrobial activity.

In a preferred embodiment the first enzyme is an oxidase the activity of which results in the formation of a peroxide, including hydrogen peroxide. The amount of hydrogen peroxide generated in accordance with the present invention depends on the amount of available compound on which the at least one oxidase can act. It will be possible to determine the amount of hydrogen peroxide generated by using the method of Janssen and Ruelius disclosed in Biochem. Biophys. Acta (1968), vol. 151, pages 330-342.

The amount of hydrogen peroxide generated is in preferred embodiments about or at least about 1 nmol/cm²/day, for example 5 nmol/cm²/day, such as 10 nmol/cm²/day, for example 20 nmol/cm²/day, such as 30 nmol/cm²/day, for example 40 nmol/cm²/day, such as 50 nmol/cm²/day, for example 75 nmol/cm²/day, such as 100 nmol/cm²/day, for example 150 nmol/cm²/day, such as 200 nmol/cm²/day, for example 300 nmol/cm²/day, such as 400 nmol/cm²/day, for example 500 nmol/cm²/day, such as 600 nmol/cm²/day, for example 700 nmol/cm²/day, such as 800 nmol/cm²/day, for example 900 nmol/cm²/day, such as 1000 nmol/cm²/day.

Preferred oxidases include, but are not limited to, malate oxidase; glucose oxidase; hexose oxidase; cholesterol oxidase; arylalcohol oxidase: galactose oxidase; alcohol oxidase; lathosterol oxidase; aspartate oxidase; L-amino-acid oxidase; D-amino-acid oxidase; amine oxidase; D-glutamate oxidase; ethanolamine oxidase; NADH oxidase; urate oxidase (uricase); superoxide dismutase; and rMn oxidase.

In one preferred embodiment the first enzyme is a hexose oxidase, including, but not limited to any oxidoreductase of class EC 1.1.3.5. Hexose oxidases are enzymes which in the presence of oxygen is capable of oxidising D-glucose and several other reducing sugars including maltose, lactose and cellobiose to their corresponding lactones with subsequent hydrolysis to the respective aldobionic acids. Hexose oxidase differs from another oxidoreductase, glucose oxidase, which can only convert D-glucose, in that the enzyme can utilise a broader range of sugar substrates.

Hexose oxidase is produced naturally by several marine algal species. Such species are found inter alia in the family Gigartinaceae. In one preferred embodiment the hexose oxidase is obtained from the marine algae Chondrus cripus. Reference is made to EP 0 832 245. WO 96/40935 and WO 98/13478 also disclose the cloning and expression in recombinant host organisms of a gene encoding a protein with hexose oxidase activity.

In another preferred embodiment the compound and the enzyme, respectively, are selected from glucose/hexose oxidase; glucose/glucose oxidase; L amino acid/L amino acid oxidase; galactose/galactose oxidase; lactose/beta-galactosidase/hexose oxidase; 2-deoxyglucose/glucose oxidase; pyranose/pyranose oxidase; and mixtures thereof.

The anti-fouling species, including an antimicrobial species can be generated directly by the action of the first enzyme or in combination with an initial action of one or more precursor-degrading enzymes.

An example of a precursor-degrading enzyme is any polysaccharide-digesting enzyme, including amyloglucosidase, and an example of a precursor compound is any polysaccharide.

Thus in one embodiment the coating composition can comprise at least one oxidase such as e.g. hexose oxidase and at least one amylolytically active enzyme, such as e.g. an amyloglucosidase, and/or at least one hemicellulolytically active enzyme, such as e.g. a xylanase, and/or at least one cellulolytically active enzyme, such as e.g. a cellulase, including any combination of an oxidase with the aforementioned polysaccharide-degrading enzymes, such as an oxidase and an amylolytically active enzyme, an oxidase and a hemicellulolytically active enzyme, an oxidase and a cellulolytically active enzyme, an oxidase and an amylolytically active enzyme and a hemicellulolytically active enzyme, such as an oxidase and an amylolytically active enzyme and a cellulolytically active enzyme, and an oxidase and a hemicellulolytically active enzyme and an cellulolytically active enzyme.

As will be clear from the above description, a number of enzymes can be employed in accordance with the present invention, either alone or in any combination, including a combination wherein the at least one oxidase is also present. Further example of such enzymes are described herein below.

Esterases and lipases are triacylglycerol hydrolysing enzymes capable of splitting of fatty acids having short, medium and long chain lengths. Esterases and lipases degrade cell wall lipids and other lipid associated macromolecules at the surface of microbial organisms. Accordingly, in one embodiment the first enzyme is an esterase and the compound is an ester bond-containing species. Examples of esterases include, but are not limited to, carboxylesterase, arylesterase, acetylesterase, and the like.

In yet another embodiment the enzyme/precursor-degrading enzyme is a lipase such as, but not limited to, triacylglycerol lipase, lipoprotein lipase, and the like. Preferred are triacylglycerol lipases such as Lipolase 100L Type EX and Lipex 100L.

Proteinaceous materials involved in fouling the surfaces are subject to disruption by proteases. Families of proteolytic enzymes are well known, as reviewed in Neurath, Science 224, 350-357, 1984. Candidates for use in non-toxic anti-fouling coating compositions can be drawn from these families, trypsin and subtilisin being an example of serine proteases of type I and II, papain being an example of a sulfhydryl protease, pepsin being an example of an acid protease, carboxypeptidase A and B and thermolysin being examples of metalloproteases of type I and II. Other protease families of relevance are the aminopeptidases, the collagenases and the calcium and ATP-activated proteases.

Accordingly, in a still further embodiment the enzyme/precursor-degrading enzyme is a protease such as, but not limited to, subtilisins, chymotrypsins, trypsins, elastases, cathepsins, papains, chromopapains, pepsins, carboxypeptidase A, carboxypeptidase B, thermolysins, calcium activated proteases, ATP-activated proteases, exopeptidases such as aminopeptidases and carboxypeptidases, endopeptidases, and the like.

Enzymes/precursor-degrading enzymes capable of degrading polysaccharides are generally desirable in combination with an oxidase the activity of which results in the production of peroxide. The reason is that polysaccharide-digesting enzymes can break down a polysaccharide component of a microbial adhesive structure and/or degrade important structural polysaccharides of microorganisms into building blocks of preferably mono- and/or disaccharides. Such compounds are substrates for oxidases and their formation thus enhances the subsequent production of peroxides. Additionally, the polysaccharide-digesting enzymes of the present invention can prevent or interfere with the attachment process or the subsequent growth, metamorphosis or replication of the fouling organisms in question.

Accordingly, in a still further embodiment the enzyme/precursor-degrading enzyme is a polysaccharide-digesting enzyme, such as, but not limited to, alpha-amylase, beta-amylase, beta-glucosidase, glucosidase, glycosidase, cellulase, pectinase, hyaluonidase, beta-glucuronidase. A preferred pectinase is Pectinex Ultra SP, a polygalacturonase. Preferred cellulases are Carezyme 4500L (a mono-component cellulase), Denimax 991L (an acid cellulase), Cellusoft L (an endo-glucanase) and Endolase 5000L (a mono-component cellulase).

The enzymes beta-amylase, beta-glucosidase, and glycosidase all belong to the group of enzymes that can degrade polysaccharides. Pectinase and cellulase are enzymes which break down pectin and cellulose, respectively, two ubiquitous structural polymers of the plant cell wall and cell wall connective tissue matrix. Lysozyme and achromopeptidase can also break cell walls, the latter having an exceptional range of activity against microorganisms. Hyaluronic acid and collagen have analogous structural roles in animals and are degraded by hyaluronidase and collagenase, respectively. Beta-Glucuronidase will also break down hyaluronic acid.

Preferred polysaccharide-degrading enzymes in accordance with the present invention are e.g. “hemicellulolytically active” enzymes, “cellulolytically active” enzymes, and “amylolytically active” enzymes. To the first group belong enzymes such as xylanases, which have the capability to degrade at least one substance belonging to the group of compounds and precursor compounds generally referred to as hemicellulose, including xylans and mannans, such as Endo-1,4-beta-xylanase (E.C. 3.2.1.8), Xylan endo-1,3-beta-xylosidase (E.C. 3.2.1.32), Glucuronoarabinoxylan endo-1,4-beta-xylanase (E.C. 3.2.1.136), Beta-mannosidase (E.C. 3.2.1.25), Mannan endo-1,4-beta-mannosidase (E.C. 3.2.1.78) and Mannan endo-1,6-beta-mannosidase (E.C. 3.2.1.101).

The above-mentioned enzymes occur in preferred embodiments in combination with at least one oxidase. Accordingly, when the coating composition comprises an oxidase capable of acting on a compound, wherein said action results in the formation of an antimicobial species, the coating composition can in further embodiments comprise one or more of

at least one esterase from the above group, optionally in the absence of a substrate for said esterase, and/or

at least one lipase from the above group, optionally in the absence of a substrate for said lipase, and/or

at least one protease from the above group, optionally in the absence of a substrate for said protease, and/or

at least one polysaccharide-degrading enzyme from the above group, optionally in the absence of a substrate for said enzyme.

Preferred combinations of the above enzymes in combination with the at least one oxidase include

a coating composition comprising at least one oxidase in the absence of a substrate for said oxidase and at least one hydrolytic enzyme, optionally in the absence of a substrate for such a hydrolytic enzyme,

a coating composition comprising at least one oxidase in the absence of a substrate for said oxidase and at least one esterase,

a coating composition comprising at least one oxidase in the absence of a substrate for said oxidase and at least one lipase,

a coating composition comprising at least one oxidase in the absence of a substrate for said oxidase and at least one protease,

a coating composition comprising at least one oxidase in the absence of a substrate for said oxidase and at least one polysaccharide digesting enzyme,

a coating composition comprising at least one oxidase in the absence of a substrate for said oxidase and at least one esterase and at least one lipase,

a coating composition comprising at least one oxidase in the absence of a substrate for said oxidase and at least one esterase and at least one protease,

a coating composition comprising at least one oxidase in the absence of a substrate for said oxidase and at least one esterase and at least one polysaccharide digesting enzyme,

a coating composition comprising at least one oxidase in the absence of a substrate for said oxidase and at least one esterase and at least one lipase and at least one protease,

a coating composition comprising at least one oxidase in the absence of a substrate for said oxidase and at least one esterase and at least one lipase and at least one polysaccharide digesting enzyme,

a coating composition comprising at least one oxidase in the absence of a substrate for said oxidase and at least one esterase and at least one lipase and at least one protease and at least one polysaccharide digesting enzyme,

a coating composition comprising at least one oxidase in the absence of a substrate for said oxidase and at least one lipase and at least one protease,

a coating composition comprising at least one oxidase in the absence of a substrate for said oxidase and at least one lipase and at least one protease and at least one polysaccharide digesting enzyme, and

a coating composition comprising at least one oxidase in the absence of a substrate for said oxidase and at least one protease and at least one polysaccharide digesting enzyme.

In various embodiments, the above coating compositions—in addition to the lack of substrate for the at least one oxidase—also do not comprise any substrate for at least one other enzyme. Accordingly, there are provided embodiments wherein any one of the above-mentioned coating compositions i) does not comprise any substrate for the at least one esterase, when an esterase is present, ii) does not comprise any substrate for the at least one lipase, when a lipase is present, iii) does not comprise any substrate for the at least one protease, when a protease is present, and iv) does not comprise any substrate for the at least one polysaccharide-digesting enzyme, when a polysaccharide-digesting enzyme is present.

In further embodiments the above coating compositions according to the invention i) do not comprise a substrate for an esterase and a lipase, when at least an esterase and a lipase are present, optionally in combination with further enzymes ii) do not comprise a substrate for an esterase and a protease, when at least an esterase and a protease are present, optionally in combination with further enzymes, iii) do not comprise a substrate for an esterase and a polysaccharide digesting enzyme, when at least an esterase and a polysaccharide digesting enzyme are present, optionally in combination with further enzymes, iv) do not comprise a substrate for an lipase and a protease, when at least a lipase and a protease are present, optionally in combination with further enzymes, v) do not comprise a substrate for a lipase and a polysaccharide digesting enzyme, when at least a lipase and a polysaccharide digesting enzyme are present, optionally in combination with further enzymes, and vi) do not comprise a substrate for a protease and a polysaccharide digesting enzyme, when at least a protease and a polysaccharide digesting enzyme are present, optionally in combination with further enzymes.

In the present context the term “an effective amount” means an amount which is sufficient to at least partially reduce or prevent the settling of aquatic organisms such as bacteria, protozoa, algae and invertebrates on a surface coated with the composition according to invention. In order to test the amount of protease required in order to sufficiently reduce or prevent fouling, any type of standard or modified anti-fouling bioassay can be applied, including settlement assays as described by Willemsen (1994) Int. Biodeterior. Biodegrad. 34: 361-373.

In order to test the amount of the enzyme or enzymes required in order to sufficiently reduce or prevent fouling, any type of standard or modified anti-fouling bioassay can be applied, including settlement assays as described by Willemsen (1994).

In one presently preferred embodiment, the amount of the enzyme is in the range of from about 0.1 to preferably less than 10% (w/w) coating composition (dry weight), such as from about 0.1 to less than 9% (w/w), for example from about 0.1 to less than 8% (w/w), such as from about 0.1 to less than 7% (w/w), for example from about 0.1 to less than 6% (w/w), such as from about 0.1 to less than 5.5% (w/w), for example from about 0.1 to less than 5.0% (w/w), such as from about 0.1 to less than 4.5% (w/w), for example from about 0.1 to less than 4.0% (w/w), such as from about 0.1 to less than 3.5% (wlw), for example from about 0.1 to less than 3.0% (w/w), such as from about 0.1 to less than 2.5% (w/w), for example from about 0.1 to less than about 2.0% (w/w), such as from about 0.1 to less than about 1.5% (w/w), for example from about 0.1 to less than about 1.0% (w/w), such as from about 0.1 to less than about 0.5% (w/w).

In another embodiment the amount of the enzyme is present in the coating composition in the range of from about 0.2% (w/w) to about 0.4% (w/w) coating composition (dry weight), such as from about 0.4% (w/w) to about 0.6% (w/w), for example from about 0.6% (w/w) to about 0.8% (w/w) coating composition, such as from about 0.8% (w/w) to about 1.0% (w/w), for example from about 1.0% (w/w) to about 1.2% (w/w) coating composition, such as from about 1.2% (w/w) to about 1.4% (w/w), for example from about 1.4% (w/w) to about 1.6% (w/w) coating composition, such as from about 1.6% (wlw) to about 1.8% (w/w), for example from about 1.8% (w/w) to about 2.0% (w/w) coating composition, such as from about 2.0% (w/w) to about 2.5% (w/w), for example from about 2.5% (w/w) to about 3.0% (wlw) coating composition, such as from about 3.0% (w/w) to about 3.5% (wlw), for example from about 3.5% (w/w) to about 4.0% (w/w) coating composition, such as from about 4.0% (w/w) to about 4.5% (w/w), for example from about 4.5% (w/w) to about 5.0% (w/w) coating composition.

Rosins

The coating composition according to the invention can further comprise a rosin compound. Rosin is a solid material that e.g. occurs naturally in the oleo rosin of pine trees and is typically derived from the oleo resinous exudate of the living tree, from aged stumps and from tall oil produced as a by-product of kraft paper manufacture.

Rosin compounds have a number of highly desirable properties for use as binders in anti-fouling paints such as e.g. being fairly non-toxic to humans, being compatible with a large number of other binders and being relatively inexpensive and readily available from natural resources.

Thus, rosins are used in paints as binders, and thereby provide a rather non-toxic alternative to synthetic and more toxic binders such as e.g. polymeric binder components as epoxy, polyvinylacetate, polyvinylbutyrate and polyvinylchloride acetate.

Rosin is typically classed as gum rosin, wood rosin, or as tall oil rosin which indicates its source. The rosin materials can be used unmodified, in the form of esters of polyhydric alcohols, in the form of rosins polymerised through the inherent unsaturation of the molecules or in the form of hydrogenated rosin. Thus, rosin can be further treated by e.g. hydrogenation, dehydrogenation, polymerisation, esterification, and other post treatment processes. Additionally, rosin with e.g. free carboxylic acid groups are capable of reacting with metals and thereby forming rosin metal salts.

Accordingly, the rosin compound of the anti-fouling coating composition of the present invention is at least one selected from rosins, rosin derivatives, and rosin metal salts. Examples of rosins include tall rosin, gum rosin, and wood rosin. Examples of rosin derivatives include hydrogenated rosins, modified rosins obtained by reacting rosins with maleic anhydride, formylated rosins, and polymerised rosins. Examples of rosin metal salts include zinc rosinates, calcium rosinates, copper rosinates, magnesium rosinates, and products of the reaction of rosins with compounds of other metals.

Rosins of natural origin have the beneficial effect that when used in combination with enzymes the activity of the enzymes are not substantially affected by the rosins as compared to enzymes in paint compositions prepared with synthetic binders of non-natural origin. Accordingly, it was found that no enzyme activity was present in paint compositions comprising protease and synthetic binders of non-natural origin.

The rosins are furthermore believed to have an immobilising effect on the enzymes and thus preventing the enzymes from being released from the coating composition into the environment.

When the coating composition according to invention comprises a rosin compound, the content of the rosin compound preferably is in the range of from about 5 to about 60% by weight. It is more preferred that the amount of rosin compound is higher than about 10% such as up to about 20% by weight. However, it is also contemplated that the amount of rosin compound in the composition can be up to about 30%, such as up to about 40%, up to about 50% and up to about 55%. Thus, a pigmented composition according to the invention could advantageously comprise an amount of rosin compound in the range of about 10-30% by weight, and a lacquer composition could comprise up to about 60% of rosin compound by weight.

Further Components of the Coating Composition

In order to improve the efficiency of the anti-fouling paint composition according to the invention, the composition can be combined with further biologically active agents known to suppress the settlement of marine organisms. Thus, in one embodiment the composition according to invention additionally comprises at least one algicide, herbicide, fungicide, molluscicide or other compound exhibiting anti-fouling activity.

The coating composition of the invention can also comprise additional agents useful for preventing fouling, particularly macrofouling. One such group of agents is termed repellants of the macrofouling organisms. Repellants belong to a group of biologically active compounds which repell rather than attract microbial organisms.

Repellants according to the invention include molecules that are customarily associated with some inimicable material formed by a predator (or other non-compatible organism) of the macrofouling organism. An example is the material customarily excreted by starfish that causes such prey organism as scallops to immediately react to the material and try to escape therefrom. When affixed to a surface as described herein, the repellant would not freely diffuse but would act to elicit the escape response when the organism contacted the surface being protected. An example of this would be a purified chemical repellant or an impure suspension containing the active chemical repellant that is obtained by grinding and partially fractionating a coral or algae preparation. The repellants of choice are those natural products used by corals, seaweeds and other aquatic organisms to avoid fouling of their surfaces.

In addition to natural products that can act as repellants, the surface protection can also be brought about by affixing a surfactant. Some repellants will be surfactants and vice versa, but as surfactants are generally not regarded as repellants in all senses of the word, they are considered as a separate class of bioactive agents having a useful effect in combination with enzymes and/or repellants of this invention.

A surfactant can have an inhibitory effect on attachment of organisms to a surface even when immobilized on or within a coating composition of the invention. Specific examples of immobilized surfactants are cationic, anionic and non-ionic surfactants such as quaternary ammonium ions, dipalmitoyl phosphatidyl choline, aralkyl sulfonates and sucrose esters, respectively. Other examples are set forth in the Kirk-Othmer Encyclopedia of Chemical Technology, Vol. 22, pages 332-432, John Wiley & Sons, New York, 1983.

Yet another example of a compound capable of being incorporated into coating compositions according to the invention is tannic acid, a representative compound of the tannins, a family of compounds secreted by certain species of marine brown algae (e.g. Sargassum), which appear to restrict bacterial colonization of the frond surface (Sieburth and Conover (1965) Nature 208 52). This is exemplary of the class of compounds, useful in non-toxic anti-fouling coatings, that act by interference with enzymatic reactions necessary for attachment of macro- or micro-organisms. Candidate compounds in this category include kojic acid and similar inhibitors of polyphenol oxidase. These inhibitors will interfere with the cross-linking of cement-forming materials of similar value are glucosyl transferase inhibitors which will prevent the formation of polysaccharide adhesives used in adhesion, mutastein, ribocitrin, 1-deoxynojirimycin, acarbose, and N-methyldeoxynojirimycin being exemplary of these.

The coating composition can further comprise conventional components for paint compositions, including pigments, fillers, dispersion agents, solvents plasticisers and other additives, and the composition can e.g. be solvent-based or water-borne.

Thus, it is contemplated that the composition of the present invention can comprise—in addition to a rosin compound—one or several further synthetic binder components, such as synthetic polymeric binder components, for example polyvinylacetate, which further binder components are preferably compatible with the enzyme, i.e. the enzyme is enzymatically active when in combination with the synthetic binder.

The coating compositions of the invention described herein above can further comprise a binder to immobilise at least one of the constituents, optionally to immobilise the enzymes.

The coating compositions of the present invention can be formulated as coatings, lacquers, stains, enamels and the like, hereinafter referred to generically as “coating (s)”.

Preferably, the coating composition is formulated for treatment of a surface selected from outdoor wood work, external surface of a central heating system, and a hull vehicle should not interfere with the activity of the at least one enzyme(s) and/or any additional antifoulant compound.

Suitable solvents for coating compositions are disclosed e.g. in U.S. Pat. No. 5,071,479 and include water and organic solvents including aliphatic hydrocarbons, aromatic hydrocarbons, such as xylene, toluene, mixtures of aliphatic and aromatic hydrocarbons having boiling points between 100° C. and 320° C., preferably between 150° C. and 230° C.; high aromatic petroleum distillates, e. g., solvent naptha, distilled tar oil and mixtures thereof; alcohols such as butanol, octanol and glycols; vegetable and mineral oils; ketones such as acetone; petroleum fractions such as mineral spirits and kerosene, chlorinated hydrocarbons, glycol esters, glycol ester ethers, derivatives and mixtures thereof.

The solvent may be apolar or polar, such as water, optionally in admixture with an oily or oil-like low-volatility organic solvent, such as the mixture of aromatic and aliphatic solvents found in white spirits, also commonly called mineral spirits.

The solvent may typically contain at least one of a diluent, an emulsifier, a wetting agent, a dispersing agent or other surface active agent. Examples of suitable emulsifiers are disclosed in U.S. Pat. No. 5,071,479 and include nonylphenol-ethylene oxide ethers, polyoxyethylene sorbitol esters or polyoxyethylene sorbitan esters of fatty acids, derivatives and mixtures thereof.

Any suitable surface coating material may be incorporated in the composition and/or coating of the present invention. Examples of trade-recognized coating materials are polyvinyl chloride resins in a solvent based system, chlorinated rubbers in a solvent based system, acrylic resins and methacrylate resins in solvent based or aqueous systems, vinyl chloride-vinyl acetate copolymer systems as aqueous dispersions or solvent based systems, butadiene copolymers such as butadiene-styrene rubbers, butadiene-acrylonitrile rubbers, and butadiene-styrene-acrylonitrile rubbers, drying oils such as linseed oil, alkyd resins, asphalt, epoxy resins, urethane resins, polyester resins, phenolic resins, derivatives and mixtures thereof.

The composition and/or coating of the present invention may contain pigments selected from inorganic pigments, such as titanium dioxide, ferric oxide, silica, talc, or china clay, organic pigments such as carbon black or dyes insoluble in sea water, derivatives and mixtures thereof.

The coating composition of the present invention can also contain plasticisers, rheology characteristic modifiers, other conventional ingredients and mixtures thereof.

The coating composition of the present invention optionally further comprise an adjuvant conventionally employed in compositions used for protecting materials exposed to an aquatic environment. These adjuvants may be selected from additional fungicides, auxiliary solvents, processing additives such as defoamers, fixatives, plasticisers, UV-stabilizers or stability enhancers, water soluble or water insoluble dyes, color pigments, siccatives, corrosion inhibitors, thickeners or antisettlement agents such as carboxymethyl cellulose, polyacrylic acid or polymethacrylic acid, anti-skinning agents, derivatives and mixtures thereof.

It is further contemplated that the composition according to the invention may comprise binder components such as silan compounds. Such silans may in useful embodiments be selected from silane esters, vinyl silanes, methacryloxy silanes, epoxy silanes, sulfur silanes, amino silanes, and isocyanoto silanes.

Additionally the anti-fouling paint composition can further comprise one or more fillers, such as kaolin, silica and dolomite.

In one embodiment of the present invention, the enzyme is encapsulated, such as encapsulated by a semi-permeable membrane. One type of enzymes may be encapsulated individually independently of other types of enzymes, or the enzymes may be encapsulated together. The encapsulating material may be selected such that on contact with a foulant, the enzyme may be released. In this way, a composition may be provided which only provides an anti-foulant species or increases provision of an anti-foulant compound when contacted with a foulant. Alternating layers of anti-foulant species and encapsulation material ensures a sequential release of enzymes.

As discussed in U.S. Pat. No. 5,071,479, the coating composition of the present invention can also include additional ingredients known to be useful in preservatives and/or coatings. Such ingredients include fixatives such as carboxymethylcellulose, polyvinyl alcohol, paraffin, co-solvents, such as ethylglycol acetate and methoxypropyl acetate, plasticisers such as benzoic acid esters and phthlates, e. g., dibutyl phthalate, dioctyl phthalate and didodecyl phthalate, derivatives and mixtures thereof. Optionally dyes, color pigments, corrosion inhibitors, chemical stabilizers or siccatives (dryers) such as cobalt octate and cobalt naphthenate, may also be included depending on specific applications.

The composition and/or coating of the present invention can be applied by any of the techniques known in the art including brushing, spraying, roll coating, dipping and combinations thereof.

Compositions of the present invention can be prepared simply by mixing the various ingredients at a temperature at which they are not adversely affected. Preparation conditions are not critical. Equipment and methods conventionally employed in the manufacture of coating and similar compositions can be advantageously employed.

Anti-Fouling Effects of the Coating Composition

The coating compositions of the invention are capable of reducing and/or eliminating fouling in the form of microbial growth and/or the formation of bio-film on objects coated with the composition. The microbial organisms can be e.g. bacteria, vira, fungal cells and slime molds. For aquatic environments, the microbial organisms are marine organisms.

In selecting the enzyme(s) of the coating composition one must take into consideration—among other things—the type of surface being protected, the environment in which the surface is found, and the organism against which protection is being sought.

The general principle underlying the choice of enzyme to be immobilized is that the abundance of a particular type of enzyme should be proportional to the probable frequency of surface contact with the target organism against which the anti-fouling species, including an antimicrobial species generated by the enzyme, has anti-fouling efficacy.

As an example, a short-term protection against settling organisms in a marine environment can focus on deterring the formation of films that are deposited by the settlement and growth of marine algae and bacteria. In this case, the bioactive materials to be incorporated on the surface can be distributed equally between a bactericide and an algaecide.

Accordingly, the antimicrobial effects of the compositions according to the invention are directed to—among others—the following groups of microbial organisms: Bacteria, fungi, algae, protozoa, porifera, coelenterata, platyhelminthes, nemertea, rotifera, bryozoa, brachiopoda, annelida, arthropoda, mollusca, echinodermata and chordata.

One interesting case is that of preventing growth and/or attachment to a surface of Vibrio species in an aquatic environment. Vibrio species often cluster together due to the presence of an extracellular polysaccharide (slime) that they synthesize. The best-known species of Vibrio is V. cholerae which causes cholera, a severe diarrhoeal disease resulting from a toxin produced by bacterial growth in the gut. Accordingly, the present invention in one preferred aspect also relates to preventing and/or reducing the risk of cholera outbreaks in environments wherein V. cholerae is present. The method includes the step of coating pipes, filters, tanks and the like with a composition according to the invention comprising at least one oxidase and a polysaccharide degrading enzyme capable of degrading polysaccharides secreted by Vibrio species including V. cholerae.

The development of an anti-fouling species, including an antimicrobial species which could eliminate only, for example, barnacles in an aqueous environment would be solving only part of the fouling problem. Studies on the temporal development of a fouling community have revealed that bacteria are usually the first organisms to colonize a submerged surface. Attached bacteria produce a secondary extracellular polymeric adhesive, and eventually the surface of the substratum becomes coated with bacteria embedded within this extracellular matrix (collectively referred to as a bacterial film).

The rate of subsequent colonization by other microorganisms, and by marine invertebrate larvae, is often dependent upon the initial formation of a bacterial film. Consequently, the development of a coating composition capable of reducing and/or eliminating the process of bacterial film formation can be expected also to have a significant anti-fouling effect.

A small number of proteins and carbohydrates constitute the important structural elements of the cell wall of a wide range of microbial organisms. Collagen, cellulose, and chitin are three abundant structural polymers. Chitin, for example, is an important constituent of the shell matrix of the inarticulate Brachipoda, the exoskeleton of the Ectoprocta (e.g. Bryozoa), the walls of sponge gemmules (the dispersal stage of the sponge life cycle), the perisarc (the outer layer of the integument) of hydrozoan coelenterates, the cell wall of fungi, and the cuticle of all arthropods. Additional relevant polysaccharides are mannans, galactomannans, alginates, laminarins, carregeenans (iota and kappa), and agars.

Any enzyme capable of degrading any one or more of the above polymers, including collagen and/or cellulose and/or chitin can therefore be included into the coating composition of the invention, optionally in the absence of a substrate for such an enzyme, and preferably in combination with an oxidase.

The integument of most fouling organisms is the principal organ of permanent post-metamorphic attachment and adhesion. Interference with the synthesis of an important biochemical constituent of the cell wall or integument, or any degradation of such structural elements or interference with the enzymatic processes involved in adhesion would therefore exert a strong anti-fouling action. In a region that is heavily populated with barnacle larvae, enzymes which specifically retard the settlement of the barnacle larva would be more important and should be incorporated on a surface, preferably in larger proportion.

The coating compositions according to the invention in one embodiment result in the formation of a monolayer of enzymes located on the surface of an object. For example, an enzyme having a molecular weight of approximately 50,000 daltons would give a monolayer when spaced on a surface with a distance of approximately 40 angstroms between the centers of adjacent molecules. This spacing assumes a Stokes radius of approximately 20 angstroms. However, it is not essential that a complete monolayer is present. A desirable activity can be maintained with the spacing of bioactive compounds over greater distances. A spacing of no more than 1,000 angstroms and more preferably no more than 100 angstroms is preferred in order to insure that a biologically active chemical is available for reaction with a fouling organism at each point of initial contact.

The coating compositions of the invention can be used in all types of environments, including non-aquatic as well as aquatic environments, including sea-water, estuary, and fresh water environments. In addition to natural environments (i.e., those which are in free contact with and freely exchange material with other parts of the biosphere without human intervention), the term “aquatic environments” as used herein also includes cooling towers, fresh and salt water piping systems, desalination and other filtration systems containing membrane “surfaces” subject to protection, and other aquatic environments which rely upon the intervention of human beings for their creation and maintenance.

As used herein, the term “natural environment” includes ponds, lakes, dredged channels and harbors, and other bodies of water which were initially produced by the action of human beings but which do not rely upon human intervention for the supply of water into and out of such environments.

Marine Fouling Organisms

While many fouling organisms such as barnacles and algae are well known to the general public, those skilled in the art will recognize that the term fouling organism as used herein refers to any living organism which is capable of attaching to a surface in an aquatic environment.

Algae represents one group of marine fouling organisms. The group of algae is very diverse and probably not related to one another. There are 6 divisions of algae, some unicellular and some multicellular. In some taxonomic schemes, the last three divisions are included in the Kingdom Protista which includes all eukaryotic, unicellular organisms, regardless of their mode of nutrition. Algae can be characterised with respect to e.g.:
i) Photosynthetic pigments. Some pigments mask the chlorophylls and give their name to the common name of the division—Brown algae. The accessory pigments participate with the PS II reaction center.
ii) Food storage chemistry is an important distinguishing feature. Not all organisms store energy in the form of starch as do most plants. There are unique storage chemicals for the various division.
iii) Flagella structure is a good distinguishing feature for those division that have flagellated cell. The number of flagella, morphology of the flagellum and its orientation characterize divisions.
iv) Cell wall chemistry is another distinguishing feature.
v) The habitat of members of the division can also be relevant for characterization.

The above criteria are used herein below to characterise different forms of algae.

Rhodophyta are the red algae and can be characterised as described below:
1. Pigments—the phycobolins, phycoerthrin and phycocyanin are the pigments that usually mask the chlorophyll a that is common to all algae and the green plants.
2. Food storage materials—Floridean starch is a polysaccharide material.
3. Cell wall materials—The red algae possess a microfibrillar network of polysaccharide material (cellulose or some other) embedded within a mucilaginous matrix such as agar. Some marine forms may produce CaCO₃ in their walls to give them a rigid structure.
4. Types and number of flagella—The red algae never produce motile cells. Not only do they not produce motile cells, it appears that they may never have had motile cells.
5. Habitat—The red algae are mostly marine organisms but a few freshwater types do exist.
6. The life cycles of red algae are complicated by the presence of a third generation type in addition the sporophyte and gametophyte.

Phaeophyta are the brown algae. This group includes the kelps and rockweeds.
1. Pigments—The Brown algae have fucoxanthin as an accessory pigment to mask the chlorophyll a and c, giving them the brownish color.
2. Food storage materials—Lamanarin is a polysaccharide food storage material unique to the brown algae.
3. Cell wall materials include a mucilaginous material called algin that is harvested from kelps.
4. Types and number of flagella—The brown algae have heterokont flagellated cells. One is an anteriorly-oriented tinsel-type flagellum and the other flagellum is a posteriorly-oriented whiplash type.
5. Habitat—The brown algae are all marine organisms.
6. Several life cycle types are exemplified by the brown algae.
   Ectocarpus is a filamentous alga that has an isomorphic alternation of generations.
   Laminaria is a kelp that has a heteromorphic alternation of generations. The gametophyte is microscopic, whereas the sporophyte is macroscopic.
   Fucus is a rockweed that has gametic meiosis. There is no alternation of generations for this organism. The gametangia, antheridia and oogonia, are produced within a conceptacle. Many conceptacles are located on a receptical at the end of the dichotomously branched thallus. Meiosis occurs in the production of the gametes.

Chlorophyta are the green algae. Because of the similarity in pigmentation, cell division, and food storage materials, the land plants are thought to be derived from the Chlorophyta.
1. Pigments—Chlorophyll b is the accessory pigment.
2. Food storage materials are starch.
3. Cell wall materials—are primarily cellulose but some marine forms may add CaCO₃.
4. Types and number of flagella of the chlorophyta are isokonts with whiplash flagella.
5. Habitat of chlorophyta is freshwater and marine.
6. Taxonomy of the chlorophyta is divided into three classes based on method of cell division, insertion of flagella and internal cell structure.
   Method of cell division refers to the production of a phragmoplast or a phy phycoplast.
   Insertion of flagella are either apical or subapical.
   Internal cell structure refers to the possession of a system of microtubules found near the flagella apparatus. Also the possession of peroxisomes involved in photoresiration.
7. Classes of Chlorophyta
   Charophyceae are the group most like the land plants. They undergo mitosis by formation of a phragmoplast, possess the microtubular system characteristic of land plants, and have subapically inserted flagella. Example organisms in this group are Spyrogyra, the desmids and Coleochaeta.
   The Ulvaphyceae are mostly marine organisms that have an alternation of generation. The life cycle of Ulva has an isomorphic alternation of generations with sporic meiosis. These organisms produce a phycoplast when undergoing cell division and the nuclear envelope persists during division.
   Chlorophyceae produce a phycoplast when undergoing cell division and the nuclear envelope persists during division. There are many forms that have zygotic meiosis like Chlamydamonas.

Chrysophyta are unicellular algae.
1. Characteristics of the Chrysophyta indicate a similarity with the brown algae. There are three classes of chrysophyta.
   Pigments include chlorophyll a and chlorophyll c. These are usually masked by an abundance of a brownish pigment, fucoxanthin.
   Food reserve in the Chrysophyta is called chrysolaminarin—a carbohydrate.
   The cell of chrysophytes may be naked or they may have cell walls of cellulose. Some members have silica scales or shells.
2. Classes of Chrysophyta
   Chrysophyceae are primarily freshwater planktonic organisms. They lack a clearly defined cell wall but have silica scales. Many of these organisms have flagella.
   Bacillariophyceae are the diatoms. These are important phytoplanktonic organisms in freshwater and marine environments. They are characterized by the presence of silica cell walls with intricate markings. They have chlorophyll a and c and fucoxanthin which gives them a brownish color. When they undergo sexual reproduction, the only flagellated cell appears, a males sperm cell. It has two flagella, one whiplash and one tinsel type.
   Xanthophyceae are the yellow green algae because they lack fucoxanthin and the greenish colors show. Vaucheria, which you saw in lab belongs to this class.

Pyrrophyta are important phytoplanktonic organisms in freshwater and marine habitats.
1. Characteristics of Pyrrophyta
   The dinoflagellates contain chlorophyll a and c and a brownish pigment called peridinin.
   The food storage material of the pyrrophyta is starch.
   The cell walls of those that possess them are in the form of cellulosic plates and hence the name armored dinoflagellates given to some members of the phylum.
   The pyrrophyta have two flagella. One flagellum encircles the cell like a belt. The other flagellum trails behind the cell.
2. Features of the dinoflagellates
   Some of these organisms are responsible for the poisonous red tide.
   Some of these organisms are capable of bioluminescence.

Euglenophyta are unicellular algae that lack a cell wall.
1. Characteristics of the Euglenophyta
   The euglenoids posses chlorophyll a and b and carotenoids. They have the same grass green color as the green algae.
   The food storage material of the euglenoids is paramylon, a polysaccharide material
   The euglenophyta lack cell walls. Instead they have a proteinaceous coating called the pellicle. They are capable of changing shape because they lack the cell wall.
   The euglenoids have two flagella but only one flagellum emerges from a gullet at the tip of the cell. The other short flagellum is basically nonfunctional as a swimming aid.

Prevention and/or elimination or at least substantial reduction of microfouling by all or some of the above algae is within the scope of the present invention.

The term microfouling is used to denote the attachment of unicellular organisms, such as bacteria and algae, to the submerged surface. These microfouling organisms can, in some cases, secrete chemical signals which attract further organism to the surface, thereby increasing the rate of fouling. Macrofoulers (attaching organisms larger than unicellular organisms), such as barnacles, become attached to the surface after the formation of the initial microfouling layer.

As microfouling may occur before the macrofouling, any process which interferes with the attachment of microbial organisms to aquatic surfaces would decrease the total amount of fouling which takes place. Thus, an active ingredient capable of preventing the attachment of barnacles operates at the end of the fouling chain while an active species which operates to prevent the attachment of unicellular organisms such as bacteria operates at the beginning of the fouling chain. Accordingly, species which prevent microfouling may have some inhibitory effect against settlement of all types of fouling. One such particularly preferred anti-fouling species, including an antimicrobial species, is peroxides, such as hydrogen peroxide, produced by oxidases.

Additional anti-fouling organisms the growth of which is capable of being controlled by the means of the present invention as described herein include, but are not limited to crustaceans and other marine hard growth, such as:
Tube Worms: polychaetes; phylum Annelida; subclass Eunicea; family Serpulidae
Mussels: bivalves; phylum Mollusca; subclass Pteriomorphia; family Mytilidae
Clams: bivalves; phylum Mollusca; subclass Hterodonta; family Veneridae
Bryozoans: bryozoans; phylum Bryozoa; suborder Anasca and Ascophora; genus Schizoporella
Barnacles: crustaceans; phylum Arthropoda; subphylum Crustacea

However, as is clear from the description herein above, the invention also has utility against soft growth, which can impede e.g. the efficiency of hull forms, damage substrates of marine structures, generally shorten the viable life span of equipment, and escalate the cost of operation. Examples of these soft growth forms include:

Algae (Botanus): Padina, and Codium

Bryozoans (Animal): Bugula Neretina

Hydroids (Animal): Obelia

Sabellids

Delaya Marina (Marine Bacteria): Zibria

The compositions, coatings and/or paints may also function by direct attack on the surface film, disrupting its polymeric structure through e.g. hydrolysis of the proteins and polysaccharides of the film. This would interrupt the chain of events that ultimately leads to the accumulation of large amounts of marine organisms (including bacteria, fungi, barnacles, etc.) on e.g. the hull of the ship.

Such attack may be accomplished by the use of extracellular enzymes that disrupt the polysaccharides and proteins that make up the surface film. Key hydrolytic enzymes in this respect are proteases, alpha-amylases, amyloglycosidases and xylanases. Alternatively, the coatings and/or paints may function by modifying the surface tension of the marine surface to which the coatings and/or paints have been applied. Such a change in the surface tension may disrupt the colonization of the surface by undesirable marine organisms.

The methods and compositions disclosed herein may be used on a variety of surfaces, including but not limited to boat hulls, marine markers, bulkheads, pilings, water inlets, floors, roofs, and shingles. For example, the methods and compositions may be used to minimize fouling of marine markers. Such markers constitute a large category of floating objects and are greatly impaired by the accumulation of marine growth.

Similarly, the methods and compositions may be used on marine bulkheads. The accumulation of marine growth on bulkhead structures is detrimental to the bulkhead structure over the long term. Furthermore, the growth causes significant short term effects that are aesthetically displeasing and dangerous. Moreover, the harsh abrasive characteristics of the hard growth can result in major damage to vessels.

Similarly, the present invention can be used to minimize blockages due to fouling by marine growth of heat exchangers, evaporators, condensers and fire and flushing systems, thus resulting in significant decreases in maintenance costs for all categories of marine structures.

Anti-Fouling Species

It is within the scope of the invention to provide coating compositions comprising enzymes capable of converting a substrate into an anti-fouling species. Examples of anti-fouling species are described below.

Peroxides in general constitute one much preferred group of anti-fouling species, including an antimicrobial species according to the invention. Hydrogen peroxide is an example of a presently preferred anti-fouling species.

Additional preferred species having antimicrobial activity include, but are not limited to, carboxyl-group-containing species, ester-bond-containing species, hydroxyl-group-containing species, amino-group-containing species, aldehyde-group-containing species, and decomposition products of chitosan.

Any enzyme-compound combination capable of producing hydrogen peroxide can be used, including a combination wherein the enzyme is an oxidase and the compound can be oxidized by said oxidase.

A combination of said oxidase with said compounds to be oxidized thereby includes such combinations as malate oxidase-malic acid; glucose oxidase-glucose; hexose oxidase-glucose; cholesterol oxidase-cholesterol; arylalcohol oxidase-arylalcohol: galactose oxidase-galactose; alcohol oxidase-alcohol; lathosterol oxidase-lathosterol; aspartate oxidase-aspartic acid; L-amino-acid oxidase-L-amino acid; D-amino-acid oxidase-D-amino acid; amine oxidase-amine; D-glutamate oxidase-glutamine; ethanolamine oxidase-ethanolamine; NADH oxidase-NADH; urate oxidase (uricase)-uric acid; superoxide dismutase-superoxide radical; and so forth.

The enzymatic reaction between said oxidase and the compound yields hydrogen peroxide. The enzymatic reaction can proceed when either oxygen or oxygen and water are present in an external environment contacting the coating composition according to the invention. This oxygen can be supplied not only from atmospheric air but also from e.g. seawater containing dissolved oxygen. The enzymatic reaction of the invention occurs in an external environment including seawater with the result that hydrogen peroxide is produced in said environment.

The carboxyl-group-containing species includes a variety of organic acid species, e.g. aliphatic acids such as formic acid, acetic acid, propionic acid, butyric acid, caproic acid, caprylic acid, capric acid, lauric acid, myristic acid, palmitic acid, oleic acid, linoleic acid, linolenic acid, monochloroacetic acid, monofluoroacetic acid, sorbic acid, undecylenic acid, etc.; dibasic acids such as oxalic acid, etc.; aromatic carboxylic acids such as benzoic acid, p-chlorobenzoic acid, p-hydroxybenzoic acid, salicylic acid, cinnamic acid, etc.; and their derivatives and halides. Any enzyme-compound combination capable of producing a carboxyl-group-containing species can be applied.

The ester-bond-containing species mentioned above is not particularly restricted in kind but includes, among others, esters of any of said carboxyl group-containing species with aliphatic alcohols such as methyl alcohol, ethyl alcohol, propyl alcohol, butyl alcohol, pentyl alcohol, caproyl alcohol, caprylyl alcohol, capryl alcohol, lauryl alcohol, myristyl alcohol, palmityl alcohol, oleyl alcohol, etc.; esters of any of said carboxyl-group-containing species with aromatic alcohols such as phenol, benzyl alcohol, etc.; esters of any of said carboxyl-group-containing species with polyhydric alcohols such as ethylene glycol, glycerol, etc.; and esters of any of said carboxyl-group-containing species with derivatives or halides of said aliphatic alcohols, aromatic alcohols, or polyhydric alcohols.

The ester-bond-containing species mentioned above can be hydrolyzed by said esterase in the above-mentioned coating composition to produce said carboxylic group-containing species. This enzymatic reaction can proceed when water is present in the reaction system, as follows.
R₁COOR₂+H₂O=>R₁COOH+R₂OH

In the above reaction scheme, R₁ represents carboxylic residue and R₂ represents an alcohol residue.

When the above coating composition is applied to an object, the anti-fouling effect is achieved when e.g. moisture from the atmosphere is provided to the reaction resulting in the production of an anti-fouling species. When the coating composition is applied to an object to be placed in an aqueous environment e.g. in water such as seawater, the reaction resulting in the production of anti-fouling species, takes place in said water.

The amide-bond-containing species mentioned above include, but are not limited to, amides of any of said carboxyl-group-containing species with aliphatic amines such as butylamine, hexylamine, octylamine, decylamine, laurylamine, stearylamine, oleylamine, etc.; and amides of any said carboxyl-group-containing species with aromatic amines such as aniline, toluidine, xylidine, and alkylanilines such as hexylaniline, octylaniline, nonylaniline, dodecylaniline, and so forth.

The hydroxyl-group-containing species mentioned above include, but are not limited to, aliphatic alcohols such as methyl alcohol, ethyl alcohol, propyl alcohol, isopropyl alcohol, butyl alcohol, isobutyl alcohol, pentyl alcohol, isopentyl alcohol, hexyl alcohol, etc.; aromatic alcohols such as phenol, chlorophenol, and alkylphenols such as cresol, xylenol, etc., resorcinol, benzyl alcohol, etc.; and the derivatives and halides of said aliphatic or aromatic alcohols.

Any enzyme-compound combination capable of producing the hydroxyl-group-containing species can be applied. In one embodiment, the enzyme is an esterase and the compound is an ester-bond-containing species. The esterase and the ester bond-containing species include the species mentioned herein before, but are not limited to these species.

The amino-group-containing species mentioned above include, but are not limited to aliphatic amines such as butylamine, hexylamine, octylamine, decylamine, laurylamine, stearylamine, oleylamine, cyclohexylamine, etc.; and aromatic amines such as aniline, toluidine, xylidine, p-n-hexylaniline, p-n-octylaniline, p-nonylaniline, p-dodecylaniline, and so forth.

Any enzyme-compound combination capable of producing said amino-group-containing species can be used. Preferred is the case in which the enzyme is an amidase including a protease, and the compound is an amide-bond-containing species including apolypeptide. The amidase and the amide-bond-containing species include the species mentioned herein before, but are not limited to these species.

The aldehyde-group-containing species include, but are not limited to aliphatic aldehydes such as formaldehyde, glyoxal, succinaldehyde, glutaraldehyde, capronaldehyde, caprylaldehyde, caprinaldehyde, laurinaldehyde, stearinaldehyde, oleinaldehyde, etc.; benzaldehyde and its derivatives such as p-n-hexylbenzaldehyde, p-octylbenzaldehyde, p-oleylbenzaldehyde, vaniline, piperonal, etc.; salicylaldehyde, cinnamaldehyde, and so forth.

Any enzyme-compound combination capable of producing said aldehyde-group-containing species can be used, including the case in which the enzyme is alcohol dehydrogenase and the compound is an aliphatic alcohol, e.g. methanol, ethanol, etc.; the case in which the enzyme is alcohol oxidase and the compound is an aliphatic alcohol such as methanol, ethanol, etc.; the case in which the enzyme is arylalcohol dehydrogenase and the compound is an aromatic alcohol such as phenol, cresol, etc.; and the case in which the enzyme is amine oxidase and the compound is an aliphatic amine such as butylamine, hexylamine, and so forth.

Any enzyme-compound combination capable of producing a decomposition product of chitosan can be applied. Preferred is the case in which the enzyme is a chitosan-decomposing enzyme and the compound is chitosan.

Uses of the Coating Compositions According to the Invention

Preferred uses of the present invention include the following methods, but are not limited thereto:

Method for treating a surface contacted by fouling organisms, or a surface at risk of such contact, said method comprising the step of contacting the surface with a coating composition according to the invention, wherein said contacting results in eliminating said fouling or at least reducing said fouling.

Method for preventing or reducing fouling of a surface, said method comprising the step of contacting the surface with a coating composition according to the invention, wherein said contacting results in preventing or reducing fouling of said surface.

Method for treating a surface contacted by a fluid composition comprising fouling organisms, said method comprising the step of contacting the surface with a coating composition according to the invention, wherein said contacting prevents fouling of said surface, or results in a reduced fouling of said surface.

The above-mentioned surfaces can be at least partly submerged in seawater, or they can be interior or exterior surfaces of a pipe for ventilation, or interior walls in a building.

Additional methods in accordance with the present invention are:

Method for disinfecting a surface, said method comprising the step of contacting the surface with a coating composition according to the invention, wherein said contacting results in a disinfection of said surface.

Method for removing microbial organisms from a surface, said method comprising the step of contacting the surface with a coating composition according to the invention, wherein said contacting results in removing microbial organisms from said surface.

Method for coating an object, said method comprising the step of contacting the surface of the object with a coating composition according to the invention, wherein said contacting results in coating the surface of said object.

Method for sealing a surface, said method comprising the step of contacting the surface with a coating composition according to the invention, wherein said contacting results in sealing said surface from an external environment.

Method for reducing or eliminating marine corrosion, said method comprising the step of contacting the surface with a coating composition according to the invention, wherein said contacting results in reducing or eliminating marine corrosion.

Method for preserving a surface, said method comprising the step of contacting the surface with a coating composition according to the invention, wherein said contacting results in preserving said surface.

Method for killing undesirable cells, such as microbial cells, said method comprising the step of contacting the surface with a coating composition according to the invention, wherein said contacting results in killing undesirable cells, such as microbial cells.

Method for generating an anti-fouling species, said method comprising the steps of
i) providing a coating composition as defined herein comprising at least one enzyme capable of acting on a compound, wherein said action results in the formation of an anti-fouling species comprising an anti-fouling activity, wherein said compound does not form part of said coating composition,
ii) providing said compound, and
iii) forming said anti-fouling species by contacting said at least one enzyme with said compound.

Method for preparing a composition as defined herein, said method comprising the steps of
i) providing at least one self polishing polymer composition,
ii) providing at least one first enzyme capable of acting on a compound, wherein said action results in the formation of an anti-fouling species comprising an anti-fouling activity, wherein said compound does not form part of said composition, and
iii) forming said coating composition by contacting said at least one first enzyme with said hydrolysable polymer composition.

Method for generating an anti-fouling species, said method comprising the steps of providing a coating composition comprising at least one enzyme capable of acting on a compound, wherein said action results in the formation of an anti-fouling species comprising an anti-fouling activity, wherein said compound preferably does not form part of said composition, further providing said compound, and forming said anti-fouling species by contacting said at least one enzyme with said compound.

Method for preparing a painting composition according to the invention, said method comprising the steps of providing at least one pigment and at least one enzyme capable of acting on a compound, wherein said action results in the formation of an anti-fouling species comprising an anti-fouling activity, wherein said compound does not form part of said composition, further providing a carrier for said at least one enzyme, and forming said composition by contacting said at least one enzyme with said carrier.

### EXAMPLES

### Example 1

### Compositions of the Invention

Ter-polymers have been synthesized with n-butyl methacrylate (hydrophobic monomer), trimethylsilyl methacrylate (hydrolysable monomer) and different hydrophilic monomers to create a self-polishing, enzyme-compatible coating binder. The following monomers in the following weights have been used:

| Code | Monomer I | Monomer II | Monomer III |
|---|---|---|---|
| JE1388 | n- | Trimethylsilyl- | Vinylpyrolidinone |
| | butylmethacry- | methacrylate | |
| | late | | |
| JE1389 | n- | Trimethylsilyl- | Poly(ethyleneglycol- |
| | butylmethacry- | methacrylate | methylether)-methacrylate |
| | late | | |
| JE1390 | n- | Trimethylsilyl- | Hydroxy-ethylmethacrylate |
| | butylmethacry- | methacrylate | |
| | late | | |
| JE1392 | n- | Trimethylsilyl- | Methacryloyloxyethyl- |
| | butylmethacry- | methacrylate | dimethyl-3-sulfopropyl |
| | late | | ammonium |
| JE1393 | n- | Trimethylsilyl- | Zinc-methacrylate |
| | butylmethacry- | methacrylate | |
| | late | | |
| JE1394 | n- | Trimethylsilyl- | Methacryloyloxyethyl- |
| | butylmethacry- | methacrylate | dimethyl-3-sulfopropyl |
| | late | | ammonium |
| JE1395 | n- | Trimethylsilyl- | Phosphate methacrylate |
| | butylmethacry- | methacrylate | |
| | late | | |
| JE1396 | n- | Trimethylsilyl- | Phosphate methacrylate |
| | butylmethacry- | methacrylate | |
| | late | | |
| JE1397 | n- | Trimethylsilyl- | Hydroxy-ethylmethacrylate |
| | butylmethacry- | methacrylate | |
| | late | | |

Composition (weight %):

| | n- | | |
|---|---|---|---|
| | butylmethacry- | | |
| Code | late | Trimethylsilylmethacrylate | Monomer III |
| JE1388 | 71 | 24 | 5 |
| JE1389 | 71 | 24 | 5 |
| JE1390 | 71 | 24 | 5 |
| JE1392 | 71 | 24 | 5 |
| JE1393 | 71 | 24 | 5 |
| JE1394 | 71 | 24 | 5 |
| JE1395 | 71 | 24 | 5 |
| JE1396 | 71 | 24 | 5 |
| JE1397 | 71 | 24 | 5 |

Composition (mol %):

| | n- | | |
|---|---|---|---|
| | butylmethacry- | | |
| Code | late | Trimethylsilylmethacrylate | Monomer III |
| JE1388 | 72 | 22 | 7 |
| JE1389 | 76 | 23 | 2 |
| JE1390 | 73 | 22 | 6 |
| JE1392 | 75 | 22 | 3 |
| JE1393 | 75 | 22 | 3 |
| JE1394 | 75 | 22 | 3 |
| JE1397 | 73 | 22 | 6 |

The reaction was carried out in a three necked round bottom flask in 100 g toluene and with 1.00 g azo-bis-isobutyronitrile (AIBN) initiator.

At RT, oxygen was removed by several times evacuation and nitrogen purging. The temperature was raised to 85° C. and maintained for 24 hours under nitrogen.

Slightly yellowish solutions were obtained with the following properties:

| | | | Mn | Mw | |
|---|---|---|---|---|---|
| Code | Appearance | Viscosity | Kmol/g | Kmol/g | D |
| JE1388 | Clear | Viscous | 20 | 37 | 1.8 |
| JE1389 | Clear | Viscous | 27 | 77 | 2.8 |
| JE1390 | Clear | Highly viscous | Not determined | Not determined | Not determined |
| JE1392 | Turbid | Viscous | Not determined | Not determined | Not determined |
| JE1393 | Clear | Gel | Not determined | Not determined | Not determined |
| JE1394 | Turbid | Viscous | Not determined | Not determined | Not determined |
| JE1395 | Clear | Higly viscous | Not determined | Not determined | Not determined |
| JE1396 | Clear | viscous | Not determined | Not determined | Not determined |
| JE1397 | Clear | Low viscous | Not determined | Not determined | Not determined |

For viscosity reasons, the JE 1388, 1389, 1394, 1396 and 1397 monomers were chosen as candidates for further development.

“Self polishing” coatings are optionally formulated with a rosin material to obtain a better polishing effect. To this end a fully-hydrogenated rosin from Eastman: Foral AX-E has been used.

Formulations of polymeric solution and rosin (Foral AX-E) were made with:
JE 1388
JE 1389
JE 1394
JE 1396
JE 1397

In that way films were cast on a glass substrate (of predetermined weight) with 0:1, 1:3, 1:1, 3:1 and 1:0 as to rosin: acrylic polymer.

Appearance of the Dried Coatings

| Code | 0:1 | 1:3 | 1:1 | 3:1 | 1:0 |
|---|---|---|---|---|---|
| JE1388 | clear | clear | clear | clear | clear |
| JE1389 | clear | clear | clear | Clear/crist. | clear |
| JE1394 | turbid | turbid | turbid | Turbid/crist. | clear |
| JE1396 | clear | clear | clear | Clear/crist | clear |
| JE1397 | clear | clear | clear | Clear/crist | clear |

The crystals which appear at a 3:1 rosin:acrylic polymer ratio are probably rosin crystals.

Self-Polishing Experiments

In order to assess the self-polishing behavior of the binder materials that had been synthesized, a speed up method was constructed. Normally the assessment of efficacy of “self polishing” is determined by rotating disc measurements. By applying the coating on a disc shaped substrate and rotating this structure in seawater for a period of time, the consumption of coating is measured at regular intervals. However, the time needed for this kind of experiments normally takes several months.

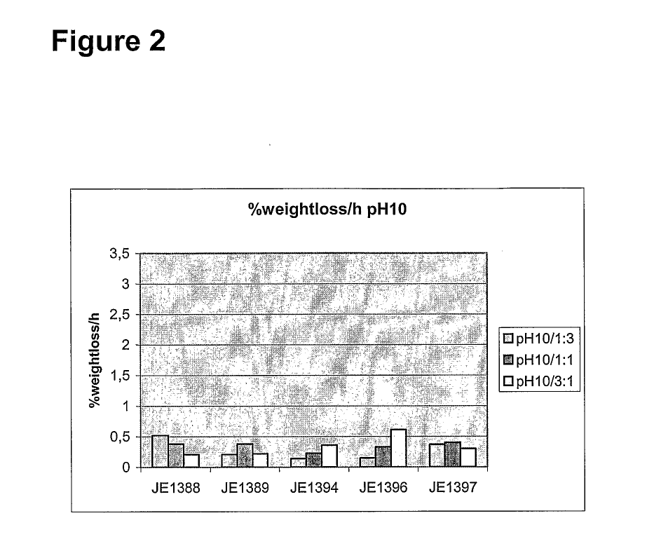

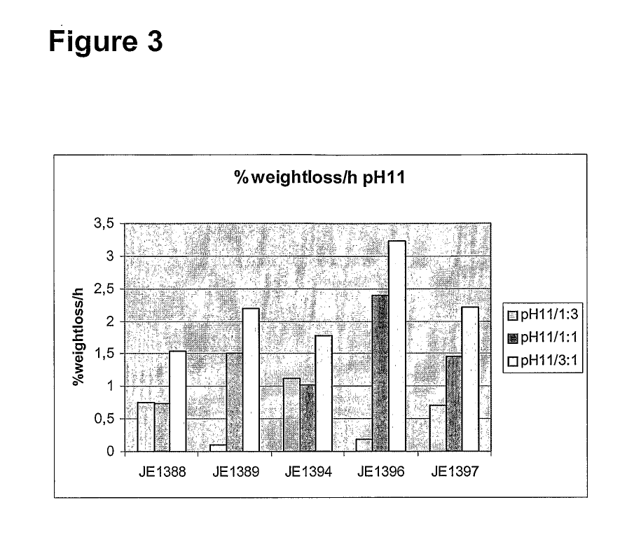

To speed up the testing (and selection) procedure, “self polishing” experiments at elevated pH's have been executed. Hydrolysis speed is highly influenced by pH, therefore a test procedure at a pH well above the pH of sea water (pH=8) is much faster in distinguishing the relative differences in “self polishing” behavior. After drying to constant weight, the polymer films were exposed to saline water (2.5% NaCl) of pH 10, 11 and 12 under stirring to determine the weight-loss over time. See FIGS. 2 and 3 for results. Apparently, the type of the hydrophilic moiety strongly influences the accelerated polishing speed of the coating system.

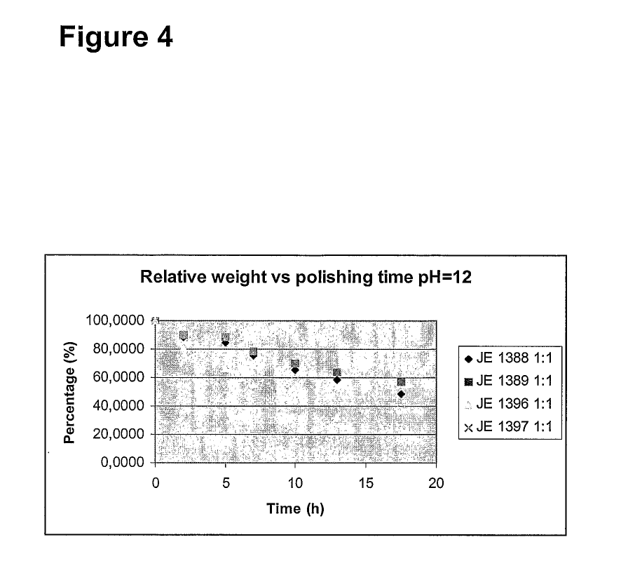

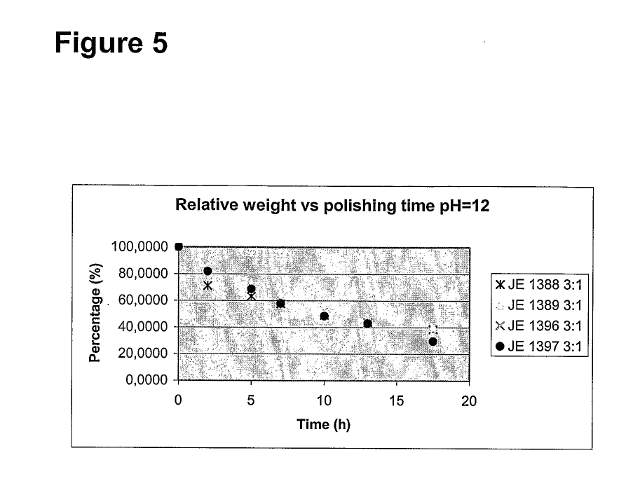

As can be seen from FIG. 5, with a ratio of rosin : acrylic polymer=3:1, the accelerated polishing is not strongly influenced by the type of the hydrophilic moiety. Comparing FIG. 4 and FIG. 5, it can be concluded that accelerated polishing speeds of the system can be tuned with the amount of rosin present in the system. The 1388 and 1389 and 1397 system polish faster with extra rosin, the 1396 system polishes slower with extra rosin.

Formulation Work on Binder-Enzyme Combinations

To make the binder solutions suitable for formulation work (low enough viscosity), all solutions have been diluted to 25 w-% in toluene. The 1388 polymer solution still showed a very high viscosity, the 1389 and 1396 polymers remained gelated, the 1394 and 1397 polymers formed a low viscous solution. The 1388, 1389 and 1396 polymers probably form physical networks, these gels could be broken into low viscous transparent solutions through the addition of small quantities of methanol or ethanol.

Addition of 0.3 g of an approx. 5% Alcalase 2.5L DX solution in water to 5 g of the different 25% polymer solutions and subsequent mixing using a Dispermat at 6000 r.p.m. for approx. 30 sec. gave white-yellowish dispersions. These dispersions (no rosin added) were coated onto glass plates.

Results:

| | Appearance without | |
|---|---|---|
| Code | enzyme | Appearance with enzyme |
| JE1388 | clear, brittle edge | slightly hazy |
| JE1389 | clear | slightly hazy |
| JE1394 | turbid, very brittle | slightly hazy, very brittle |
| JE1396 | clear, brittle edge | slightly hazy |
| JE1397 | clear | partly hazy (cloudy) |

It can be concluded that a water-based solution of the enzyme Alcalase 2.5L DX is miscable with the different toluene based polymer solutions into dispersions. These can be coated onto glass-plates to form hazy to transparent films. The 1388, 1394 and 1395 coatings without enzyme show cracking after a couple of days. To avoid cracking, coatings were also cast on an epoxy primed substrate (DeSoto CA 7012 low V.O.C. Chromate free epoxy primer, 3:1 primer:hardener). Of these coatings only the 1394 coating showed some cracking after a couple of days.

### Example 2

### Formulations and the Process of Formulation

Compositions of the invention may e.g. comprise:
Binders, optionally including rosin
Solvents
Dispersants, antifoam, etc.
Whiteners/colourants
Fillers, thickeners
Enzymes

An example of a formulation and the process of formulation is the following:

Formulation

1: Binder (50% in toluene) and Foral AX-E (50% in toluene) in desired ratio, e.g. 3:1 32 grams

2: Titanium Dioxide (Kemira 660) 14 grams

3: Talc (Luzenac 20M0) 31 grams

4: Solvesso 100 11 grams

5: Methyl isobuthyl ketone 11 grams

6: Bentone SD1 1 grams

7: Alcalase 2.5L 5 grams

Equipment

A 250 ml tin container with 6 cm diameter.

A dispersion impeller with 5 cm diameter

Method

Mix the binder solution and the Foral AX-E solution for 5 minutes at 1000 rpm.

Add 4 and 5 and mix 5 minutes at 1000 rpm.

Add 6, 2 and 3 (in this order) and disperse at 1600 rpm until 20 microns fineness of grind (if necessary grinded in bead mill).

Add 7 and mix for 10 minutes at 2400 rpm. Temperature must stay below 45° C.

### Example 3

### Preparation of a Coating Composition Using Jeffamines

The polyesters described in U.S. Pat. No. 6,395,866 can be used in the preparation of compositions comprising Jeffamines (see above). The metal in the main chain can be replaced by a Jeffamine. The following synthesis is described as an example:

At a temperature of 200° C. and under depressurized conditions, the following compounds have been reacted into the corresponding (carboxylic acid)-telechelic polyester

| | | |
|---|---|---|
| Lactic Acid | 622 | g |
| Monoethyleneglycol | 33 | g |
| Succinic Anhydride | 44 | g |
| Fascat 4100 (catalyst) | 0.46 | g |

This polyester had the following properties:

Viscosity: 130 cP (58.2% in toluene)

Acidity: 56.4 mg KOH/g

Subsequently, the Jeffamine D-230 was added at room temperature in the following amount:

| | | |
|---|---|---|
| Resin | 700 | g |
| D-230 | 93.7 | g |

The solution remained transparent at all stages of the amine addition.

The resulting polymer had the following properties:

Viscosity: 550 cP (64.3% in toluene)

Acidity: 48.1 mg KOH/g

### Example 4

### Enzyme Assays

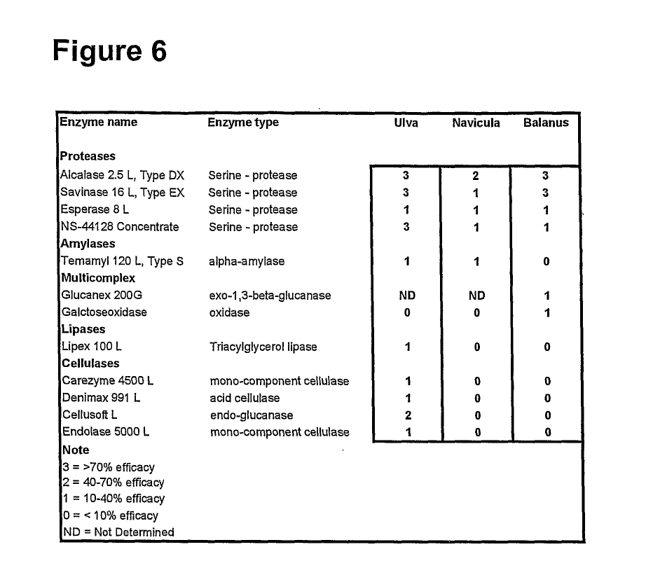

The anti-fouling activities of a number of enzymes was tested by the below procedures. Results are presented in FIG. 6.

Zoospore Adhesion Assay

Zoospores were released from fruiting thallus tissue of Ulva linza, by submersion of dried thallus in Artificial Seawater (ASW). Zoospore suspensions containing 1.5×10⁶ spores ml⁻¹ were allowed to settle on acid-washed glass microscope slides for 60 min. Slides were washed gently to remove unattached zoospores and replaced in Quadriperm dishes. A 10 ml volume of enzyme at 10³ dilution in ASW was added to batches of six settled slides, which were incubated at room temperature on a rocking platform for the desired treatment duration. Three of the slides were washed gently in ASW to remove unattached spores and fixed with 2.5% glutaraldehyde (v/v) in ASW for 20 min before washing sequentially in water with decreasing salinities. These slides thus provide the starting spore settlement levels after exposure to enzyme, but before exposure to detachment forces. The remaining three slides were exposed to a calibrated surface pressure from a water jet followed by fixation. The standard control treatment in these assays was to treat a batch of slides exactly as above, but with ASW rather than enzyme. The density of attached zoospores on the air-dried slides was determined by epifluorescence microscopy with spores being visualised by autofluorescence of chlorophyll.

Adhesion Assay for Navicula

Cells from an exponentially growing culture of Navicula perminuta, a raphid diatom, were re-suspended in fresh medium by pipetting. Cell density was adjusted to 0.3 μg ml⁻¹ chlorophyll with F2 medium and 10ml were added to three wells of a Quadriperm dish each containing an acid washed glass microscope slide. Cells were allowed to settle and adhere to slides for 2 h in an illuminated environmental cabinet at 18° C. The remaining cell suspension was aspirated and the slides washed to remove unattached cells. Slides were returned to the Quadriperm dish with the addition of 10 ml of enzyme solution, diluted to 10³ (v/v) with F2 medium. The dishes were incubated in the light at 18° C for 4 h, before slides were either fixed (controls) or exposed to a fully-developed turbulent flow for 5 min at 53 Pa wall shear stress in a water channel apparatus. Exposed slides were then fixed, and differences in the cell density on exposed and control slides quantified microscopically.

Furthermore, a barnacle assay was performed as described in Hellio et al. (2004) Mar. Biotechnol. 6:67-82.

1. A self-polishing anti-fouling coating composition comprising
i) a first enzyme having anti-fouling activity, and
ii) at least one hydrolysable polymer composition capable of being non-enzymatically hydrolysed in an aqueous environment,
or
i) a first enzyme having anti-fouling activity, and
ii) a second enzyme having polymer-hydrolysing activity, and
iii) at least one hydrolysable polymer composition capable of being hydrolysed by said second enzyme.

2. The self-polishing anti-fouling coating composition according to claim 1, comprising
i) a first enzyme having anti-fouling activity, and
ii) at least one hydrolysable polymer composition capable of being non-enzymatically hydrolysed in an aqueous environment.

3-5. (canceled)

6. The self-polishing anti-fouling coating composition according to claim 1, wherein the hydrolysable polymer composition comprises
i) hydrolysable moieties comprising at least one chemical bond capable of being hydrolysed non-enzymatically in an aqueous environment, wherein said hydrolysis results in partly solubilising the coating composition, and
ii) hydrophilic moieties.

7. The self-polishing anti-fouling coating composition according to claim 1, comprising further hydrophobic moieties being essentially insoluble in an aqueous environment.

8. The self-polishing anti-fouling coating composition according to claim 7, wherein said further hydrophobic moieties cannot be hydrolysed non-enzymatically in an aqueous environment.

9. The self-polishing anti-fouling coating composition according to claim 1, wherein the hydrolysable polymer composition comprises a ter-polymer comprising hydrophobic and hydrophilic moieties, wherein said ter-polymer is obtainable by co-polymerisation of
i) hydrolysable monomers comprising at least one chemical bond capable of being hydrolysed in an aqueous environment, wherein said hydrolysis results in partly solubilising the coating composition,
ii) hydrophilic monomers, and
iii) hydrophobic monomers being essentially insoluble in an aqueous environment and not being capable of being hydrolysed non-enzymatically in an aqueous environment, such as sea water.

10. (canceled)

11. The self-polishing anti-fouling coating composition according to claim 2, wherein said at least one hydrolysable polymer composition capable of being hydrolysed in an aqueous environment includes a silyl(meth)acrylate moiety represented by the formula (I): 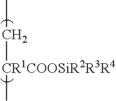
wherein R¹ is a hydrogen atom or a methyl group, and R², R³ and R⁴ may be the same or different and are each an alkyl group, a cycloalkyl group or a phenyl group which may have a substituent group.

12. (canceled)

13. The self-polishing anti-fouling coating composition according to claim 1, further comprising acrylic unsaturated monomer constituent units represented by the following formula (II): 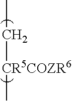
wherein R⁵ is a hydrogen atom or a methyl group, Z is an oxygen atom or —NR⁷, and wherein
when Z is an oxygen atom, R⁶ is a hydroxyalkyl or hydroxycycloalkyl group which may have a substituent group or a polyalkylene glycol group represented by the formula —(R⁸O)ₙH (wherein R⁸ is an alkylene group and n is an integer of 2 to 50), and
when Z is —NR⁷, R⁷ is an alkyl group which may be substituted with any of a halogen, a hydroxyl group, an amino group, a substituted amino group, an acyl group and an alkoxy group, and R⁶ is a hydrogen atom.

14-32. (canceled)

33. The self-polishing anti-fouling coating composition according to claim 1, wherein the first enzyme manifests an oxidase activity.

34-41. (canceled)

42. The self-polishing anti-fouling coating composition according to claim 33, further comprising at least one precursor-degrading enzyme capable of digesting a precursor compound.

43-48. (canceled)

49. The self-polishing anti-fouling coating composition according to claim 33, further comprising a protease.

50-51. (canceled)

52. The self-polishing anti-fouling coating composition according to claim 33, wherein the composition further comprises a lipase.

53. (canceled)

54. The self-polishing anti-fouling coating composition according to claim 33, wherein the composition further comprises an esterase.

55-57. (canceled)

58. The self-polishing anti-fouling coating composition according to claim 1, wherein the composition further comprises a rosin.

59. The self-polishing anti-fouling coating composition according to claim 0, wherein the rosin is selected from the group consisting of a natural rosin, a rosin derivative and a rosin metal salt.

60-67. (canceled)

68. The self-polishing anti-fouling coating composition according to claim 1, further comprising a pigment.

69. Method for treating a surface contacted by fouling organisms, or a surface at risk of such contact, said method comprising the steps of contacting the surface with a coating composition according to claim 1 with an effective amount of said coating composition, wherein said contacting results in eliminating said fouling or at least reducing said fouling.

70. Method for preventing or reducing fouling of a surface, said method comprising the steps of contacting the surface with a coating composition according to claim 1 with an effective amount of said coating composition, wherein said contacting results in preventing or reducing fouling of said surface.

71-81. (canceled)

82. Method for generating an anti-fouling species, said method comprising the steps of
i) providing a coating composition comprising at least one enzyme capable of acting on a compound, wherein said action results in the formation of an anti-fouling species comprising an anti-fouling activity, wherein said compound does not form part of said coating composition,
ii) providing said compound, and
iii) forming said anti-fouling species by contacting said at least one enzyme with said compound.

83. Method for preparing the composition according to claim 1, said method comprising the steps of
i) providing at least one self polishing polymer composition,
ii) providing at least one first enzyme capable of acting on a compound, wherein said action results in the formation of an anti-fouling species comprising an anti-fouling activity, wherein said compound does not form part of said composition, and
iii) forming said coating composition by contacting said at least one first enzyme with said hydrolysable polymer composition.
